(19) United States
(12) Patent Application Publication
(10) Pub. No.: US 2026/0285032 A1
(43) Pub. Date: Sep. 24, 2026

(54) PRINTING APPARATUS, LANDING POSITION CORRECTION METHOD, AND CONTROL DEVICE

(71) Applicant: MIMAKI ENGINEERING CO., LTD., Nagano (JP)

(72) Inventor: Wataru Hioki, Nagano (JP)

(73) Assignee: MIMAKI ENGINEERING CO., LTD., Nagano (JP)

(21) Appl. No.: 19/553,468

(22) Filed: Mar. 2, 2026

(30) Foreign Application Priority Data
Mar. 21, 2025 (JP) 2025-046588

(51) Int. Cl. B41J 2/045; B41J 2/21; B41J 11/00

(52) U.S. Cl. CPC B41J 2/04505; B41J 2/04543; B41J 2/04558; B41J 2/04573; B41J 2/2114; B41J 2/2135; B41J 11/00212; B41J 11/00214; B41J 2/04586

(57) ABSTRACT

A printing apparatus 10 includes a head unit 12, a primary scanning drive unit 18, an optical sensor 106 that is an optical detection mechanism, and a control unit 30. The head unit has a first nozzle array and a second nozzle array. Regarding an adjustment pattern including a first pattern corresponding to the first nozzle array and a second pattern corresponding to the second nozzle array, the control unit causes nozzles in the first nozzle array to discharge a first ink to discharge positions associated with the first pattern, and after the first ink is fixed to a medium 50, causes nozzles in the second nozzle array to discharge a second ink to discharge positions associated with the second pattern, and causes the optical sensor to detect reflected light after migration of the second ink that occurs due to the liquid state second ink contacting the first pattern.

### CROSS-REFERENCE TO RELATED APPLICATION

This application claims the priority benefit of Japanese application serial No. 2025-046588, filed on Mar. 21, 2025. The entirety of the above-mentioned patent application is hereby incorporated by reference herein and made a part of this specification.

### BACKGROUND

### Technical Field

The present invention relates to a printing apparatus, a landing position correction method, and a control device.

### Description of Related Art

Conventionally, printing apparatuses that perform printing with the inkjet method have been widely used. Also, regarding such printing apparatus, a configuration that performs adjustment to the deviation amount of the discharge timing (recording timing) between a plurality of nozzle arrays is known (for example, see Patent Document 1).

### Prior Art Document(s)

### Patent Document(s)

[Patent Document 1] Japanese Patent No. 5664045

### SUMMARY

According to an aspect of the present invention, a printing apparatus that performs printing with an inkjet method includes: a head unit, having a nozzle array in which a plurality of nozzles are aligned; a primary scanning drive unit, causing the head unit to perform a primary scanning operation of discharging an ink while moving in a preset primary scanning direction relative to a medium that serves as a discharge target of the ink; an optical detection mechanism, detecting reflected light at a position corresponding to an adjustment pattern that is a pattern used for correcting a landing position deviation of the ink discharged from the nozzles in the nozzle array; and a control unit, by controlling operations of the head unit and the primary scanning drive unit, causing the head unit to discharge the ink to discharge positions of the ink associated with an adjustment pattern and performing landing position correction based on the reflected light detected by the optical detection mechanism. The head unit includes: a first nozzle array that is a nozzle array for discharging a first ink which is an ink of a first color; and

a second nozzle array that is a nozzle array for discharging a second ink which is an ink of a colored color different from the first color. The adjustment pattern includes: a first pattern that is a pattern for causing at least some nozzles in the first nozzle array to discharge the first ink; and a second pattern that is a pattern for causing at least some nozzles in the second nozzle array to discharge the second ink. The control unit is configured to: cause nozzles in the first nozzle array to discharge the first ink to discharge positions associated with the first pattern, and after the first ink is fixed to the medium, cause nozzles in the second nozzle array to discharge the second ink to discharge positions associated with the second pattern; and cause the optical detection mechanism to detect the reflected light after migration of the second ink that occurs due to the second ink contacting the first pattern in a liquid state.

According to another aspect of the present invention, a landing position correction method for performing landing position correction of an ink with respect to a printing apparatus that performs printing with an inkjet method is provided. A head unit having a nozzle array in which a plurality of nozzles are aligned and an optical detection mechanism detecting reflected light at a position corresponding to an adjustment pattern that is a pattern used for correcting a landing position deviation of the ink discharged from the nozzles in the nozzle array are used. The landing position correction method includes: causing the head unit to perform a primary scanning operation of discharging the ink while moving in a preset primary scanning direction relative to a medium that is a discharge target of the ink, and causing the head unit to discharge the ink to discharge positions of the ink associated with the adjustment pattern, and performing landing position correction based on the reflected light detected by the optical detection mechanism. The head unit includes: a first nozzle array that is a nozzle array for discharging a first ink which is an ink of a first color; and a second nozzle array that is a nozzle array for discharging a second ink which is an ink of a colored color different from the first color. The adjustment pattern includes: a first pattern that is a pattern for causing at least some nozzles in the first nozzle array to discharge the first ink; and a second pattern that is a pattern for causing at least some nozzles in the second nozzle array to discharge the second ink. The landing position correction method further includes: causing nozzles in the first nozzle array to discharge the first ink to discharge positions associated with the first pattern, and after the first ink is fixed to the medium, causing nozzles in the second nozzle array to discharge the second ink to discharge positions associated with the second pattern; and causing the optical detection mechanism to detect the reflected light after migration of the second ink that occurs due to the second ink contacting the first pattern in a liquid state.

According to another aspect of the present invention, a control device for performing landing position correction of an ink with respect to a printing apparatus that performs printing with an inkjet method is provided. The printing apparatus includes: a head unit, having a nozzle array in which a plurality of nozzles are aligned; a primary scanning drive unit, causing the head unit to perform a primary scanning operation of discharging an ink while moving in a preset primary scanning direction relative to a medium that serves as a discharge target of the ink; and an optical detection mechanism, detecting reflected light at a position corresponding to an adjustment pattern that is a pattern used for correcting a landing position deviation of the ink discharged from the nozzles in the nozzle array. The head unit includes: a first nozzle array that is a nozzle array for discharging a first ink which is an ink of a first color; and a second nozzle array that is a nozzle array for discharging a second ink which is an ink of a colored color different from the first color. The adjustment pattern includes: a first pattern that is a pattern for causing at least some nozzles in the first nozzle array to discharge the first ink; and a second pattern that is a pattern for causing at least some nozzles in the second nozzle array to discharge the second ink. The control device is configured to: by controlling operations of the head unit and the primary scanning drive unit, cause the head unit to discharge the ink to discharge positions of the ink associated with the adjustment pattern and perform landing position correction based on the reflected light detected by the optical detection mechanism, cause nozzles in the first nozzle array to discharge the first ink to discharge positions associated with the first pattern, and after the first ink is fixed to the medium, cause nozzles in the second nozzle array to discharge the second ink to discharge positions associated with the second pattern, and cause the optical detection mechanism to detect the reflected light after migration of the second ink that occurs due to the second ink contacting the first pattern in a liquid state.

### BRIEF DESCRIPTION OF THE DRAWINGS

FIGS. 1A - 1C are views describing a printing apparatus 10 according to an embodiment of the present invention. FIG. 1A shows an example of a configuration of main components of the printing apparatus 10. FIG. 1B shows an example of a configuration of a head unit 12 in the printing apparatus 10. FIG. 1C shows an example of a configuration of an inkjet head 102 in the head unit 12.

FIGS. 2A and 2B are views describing an example of an adjustment pattern. FIG. 2A shows an example of a configuration of a transparent pattern 202 that forms a portion of the adjustment pattern. FIG. 2B shows an example of a configuration of a colored pattern 204 that forms another portion of the adjustment pattern.

FIGS. 3A and 3B are views describing an adjustment pattern used in the present embodiment. FIG. 3A shows an example of an adjustment pattern in an ideal state. FIG. 3B shows an example of an adjustment pattern in a state where a landing position deviation occurs.

FIGS. 4A are views describing a modified example of an adjustment pattern. FIG. 4A shows a positional relationship between a transparent pattern 202 and a colored pattern 204 in a patch corresponding to an ideal state in the present modified example. FIG. 4B shows an example of a plurality of patches used in the present modified example.

FIG. 5 is a flowchart showing an example of an operation for correcting a landing position in the printing apparatus 10.

FIGS. 6A and 6B are views describing a portion of an experiment conducted by the inventor of the present application. FIG. 6A schematically shows matters to be confirmed in the experiment. FIG. 6B shows a photograph of the results of the experiment.

FIGS. 7A to 7E are views describing a further modified example of an adjustment pattern. FIG. 7A shows an example of a configuration of a transparent pattern 202 used in the present modified example. FIG. 7B shows an example of a configuration of a colored pattern 204 used in the present modified example. FIG. 7C shows an example of an adjustment pattern used in the present modified example. FIGS. 7D and 7E show an example of a state where a landing position deviation occurs.

FIGS. 8A and 8B are views describing a further modified example of an adjustment pattern. FIG. 8A shows features of an adjustment pattern used in the present modified example in a simplified manner. FIG. 8B shows a photograph of results of the experiment conducted by the inventor of the present application in relation to the adjustment pattern of the present modified example.

### DESCRIPTION OF THE EMBODIMENTS

In a printing apparatus, when an error occurs in the discharge timing between a plurality of nozzle arrays, a deviation occurs in the landing positions of the inks discharged from nozzles in the nozzle arrays. Also, as a result, the quality of printing may be affected. Therefore, in the printing apparatus, it is desirable to correct the landing position by, for example, adjusting the discharge timing. Also, in this case, it is desirable to automate the landing position correction corresponding to the adjustment of the discharge timing. And in such case, for example, it is conceivable to perform the correction (adjustment) of the landing position by causing the printing apparatus to print a predetermined adjustment pattern and detecting the reflected light from the pattern by using an optical detection mechanism such as a reflective photosensor.

However, due to the properties of the ink used in the printing apparatus, it may become difficult to perform landing position correction by using the conventional methods. For example, in the case of using transparent inks such as clear inks and primer inks in a printing apparatus, even if an adjustment pattern is simply printed with such inks, it may be difficult for an optical detection mechanism to detect the changes in the reflected light at the positions corresponding to the pattern. Therefore, conventionally, for example, in the case where various inks are used in a printing apparatus, it has been desired to perform landing position correction with a more appropriate method. Therefore, the present invention aims to provide a printing apparatus, a landing position correction method, and a control device that can solve the issues.

The inventor of the present application conducted intensive research on a method for more appropriately performing landing position correction even in the case where a transparent ink and the like is used. Regarding the case where a printing apparatus includes a nozzle array that discharges a first ink which is an ink of a first color and a nozzle array that discharges a second ink which is a colored ink of a color different from the first color, the inventor considers printing a predetermined pattern with the first ink on a medium to be printed, and after the first ink is fixed on the medium, discharging the colored second ink to bring the second ink into contact with the pattern in a liquid state, thereby causing the second ink to move. Also, in such case, the inventor considers performing landing position correction based on changes in the light amount of the reflected light from the position of the pattern caused by the influence of the migration of the second ink. Furthermore, the inventor of the present application confirms that even in the case where a transparent ink such as a clear ink is used as the first ink, landing position correction can be appropriately performed by such a method by conducting various actual experiments and the like. And the inventor of the present application found features necessary for obtaining such effects through further intensive research, leading to the present invention.

To solve the above issues, the present invention provides a printing apparatus that performs printing with an inkjet method. The printing apparatus includes: a head unit, having a nozzle array in which a plurality of nozzles are aligned; a primary scanning drive unit, causing the head unit to perform a primary scanning operation of discharging an ink while moving in a preset primary scanning direction relative to a medium that serves as a discharge target of the ink; an optical detection mechanism, detecting reflected light at a position corresponding to an adjustment pattern that is a pattern used for correcting a landing position deviation of the ink discharged from the nozzles in the nozzle array; and a control unit, by controlling operations of the head unit and the primary scanning drive unit, causing the head unit to discharge the ink to discharge positions of the ink associated with an adjustment pattern and performing landing position correction based on the reflected light detected by the optical detection mechanism. The head unit includes: a first nozzle array that is a nozzle array for discharging a first ink which is an ink of a first color; and a second nozzle array that is a nozzle array for discharging a second ink which is an ink of a colored color different from the first color. The adjustment pattern includes: a first pattern that is a pattern for causing at least some nozzles in the first nozzle array to discharge the first ink; and a second pattern that is a pattern for causing at least some nozzles in the second nozzle array to discharge the second ink. The control unit is configured to: cause nozzles in the first nozzle array to discharge the first ink to discharge positions associated with the first pattern, and after the first ink is fixed to the medium, cause nozzles in the second nozzle array to discharge the second ink to discharge positions associated with the second pattern; and cause the optical detection mechanism to detect the reflected light after migration of the second ink that occurs due to the second ink contacting the first pattern in a liquid state.

In the case of such configuration, according to the deviation amount between the landing position corresponding to the first nozzle array and the landing position corresponding to the second nozzle array, for example, changes occur in the presence or absence of contact of the second ink with the first pattern or the manner of contact. Therefore, in such case, with the optical detection mechanism detecting the reflected light after migration of the second ink caused by the second ink in the liquid state contacting the first pattern, for example, differences occur in the detection result according to the amount of landing position deviation. Moreover, such differences in detection result occur even in the case of using a transparent ink or the like as the first ink, for example. Therefore, with such a configuration, for example, even in the case where a transparent ink or the like is used in the printing apparatus, landing position correction can be appropriately performed. Also, in this way, for example, even in the case where various inks such as a transparent ink or the like is used in the printing apparatus, landing position correction can be appropriately performed. More specifically, in this configuration, as the first ink, for example, a translucent ink that does not include a colorant can be used. As such ink, for example, a transparent ink such as a clear ink or a primer ink and the like can be suitably used. With such a configuration, for example, diverse inks can be appropriately used in the printing apparatus. Also, in the configuration, the second nozzle array is, for example, a nozzle array different from the first nozzle array. In this case, the control unit, for example, corrects the landing position corresponding to one of the first nozzle array and the second nozzle array based on the landing position corresponding to the other. With such a configuration, for example, in the printing apparatus including the first nozzle array and the second nozzle array, landing position correction can be appropriately performed. As landing position correction, for example, performing correction that reduces the deviation between the landing position of the ink discharged from the nozzles in the first nozzle array and the landing position of ink discharged from the nozzles in the second nozzle array can be considered.

In this configuration, as the first ink, for example, an ultraviolet curing type ink that cures by irradiation of ultraviolet light can be used. In this case, it is preferable to also use an ultraviolet curing type ink as the second ink. Also, in this case, the printing apparatus further includes, for example, an ultraviolet light source that irradiates ultraviolet light. And the control unit further controls, for example, the operation of the ultraviolet light source. Also, at the time of discharging the first ink to the discharge position associated with the first pattern, the control unit causes the ultraviolet light source to irradiate the ultraviolet light so that the first ink fixes to the medium at the position where the first ink lands, for example. In this case, the control unit causes the ultraviolet light source to irradiate the ultraviolet light so as to cure the first ink discharged by the first nozzle array during the primary scanning operation in each primary scanning operation, for example. Also, at the time of discharging the second ink to the discharge position associated with the second pattern, the control unit controls the operation of the ultraviolet light source so that the second ink after landing can move from the position where the second ink lands in the liquid state, for example. In this case, the control unit controls the operation of the ultraviolet light source so that the second ink after landing can move from the position where the second ink lands in the liquid state by not causing the ultraviolet light source to irradiate ultraviolet light at the time of executing the primary scanning operation that causes the second nozzle array to discharge the second ink, for example. With such a configuration, for example, the second ink in the liquid state can be appropriately brought into contact with the first pattern in a state where the first ink is fixed to the medium. Also, in this way, for example, the second ink can be appropriately moved according to the manner of contact with the first pattern.

Also, in this configuration, as the first pattern, for example, a pattern having gaps that draw the second ink that contacts in the liquid state can be used. In this case, the first pattern draws the second ink into the gaps due to the capillary phenomenon, for example. Also, in the phenomenon of drawing the second ink into the gaps of the first pattern, for example, the influence of the magnitude relationship (balance) of the surface energy between the first ink after fixing that constitutes the first pattern and the medium may occur. More specifically, for example, if the first ink has higher wettability than the medium due to the balance of the surface energy, a force that draws the second ink into the gaps of the first pattern may be generated. Therefore, the reason why the gaps of the first pattern draw the second ink can be considered not to be limited to the capillary phenomenon. Also, in this configuration, as the medium, for example, a medium in which residual traces of the color of the second ink remain even after migration of the second ink at the positions where the second ink make contact can be used. Also, in this case, the optical detection mechanism detects, for example, the reflected light that changes due to the influence of the residual traces of the color of the second ink remaining on the medium. With such a configuration, for example, the influence of the migration of the second ink can be appropriately detected by the optical detection mechanism. Also, thereby, for example, even in cases where the transparent ink is used as the first ink, correction of the landing position can be appropriately performed. More specifically, as the first pattern, for example, a pattern in which strip-shaped patterns having the primary scanning direction as the longitudinal direction are arranged in an orthogonal direction orthogonal to the primary scanning direction can be used. And in this case, as the second pattern, for example, a pattern in which gap-corresponding patterns that are patterns associated with regions sandwiched between the strip-shaped patterns are arranged in the orthogonal direction can be used. With such configuration, for example, the first pattern having gaps that draw the second ink that contacts in the liquid state due to the capillary phenomenon and the like, and the second pattern corresponding to the first pattern can be appropriately used. Also, in this way, for example, the influence of the migration of the second ink can be appropriately detected by the optical detection mechanism. Also, as the first pattern, for example, a pattern in which first unit patterns that are patterns including strip-shaped patterns having the orthogonal direction as the longitudinal direction are arranged in the primary scanning direction with predetermined intervals can be used. In this case, as the second pattern, for example, a pattern in which second unit patterns that are patterns including strip-shaped patterns having the orthogonal direction as the longitudinal direction are arranged in the primary scanning direction can be suitably used. Even with such a configuration, for example, the first pattern having gaps that draw the second ink that contacts in the liquid state due to the capillary phenomenon and the like, and the second pattern corresponding to the first pattern can be appropriately used. Also, in this way, for example, the influence of the migration of the second ink can be appropriately detected by the optical detection mechanism. Also, in this case, the second unit patterns in the second pattern are arranged in the primary scanning direction at intervals different from the intervals of the first unit patterns in the first pattern, for example. With such a configuration, the deviation amount of the landing position can be detected more appropriately.

Also, as described above, as the correction of the landing position, for example, the correction that reduces the deviation between the landing position of the ink discharged from the nozzles in the first nozzle array and the landing position of ink the discharged from the nozzles in the second nozzle array can be performed. In contrast, as a modified example of the operation of the printing apparatus, as the correction of the landing position, for example, the correction that reduces the deviation between the landing position during the primary scanning operation in one orientation in reciprocating primary scanning operations and the landing position during the primary scanning operation in the other orientation can be performed. In this case, the primary scanning drive unit causes the head unit to perform, for example, first direction scanning that is a primary scanning operation of moving the head unit relatively to the medium in one orientation in the primary scanning direction, and second direction scanning that is a primary scanning operation of moving the head unit relatively to the medium in the other orientation in the primary scanning direction. Also, in this case, as the first pattern, for example, a pattern in which ink dots formed by the ink discharged by at least some nozzles in the first nozzle array in the first direction scanning and the ink dots formed by the ink discharged by at least some nozzles in the first nozzle array in the second direction scanning overlap is used. As the second pattern, for example, a pattern which covers at least a portion of the first pattern with the second ink in the liquid state, and in which the area covering the first pattern changes according to the magnitude of the deviation amount of the landing position between the landing position of the first ink in the first direction scanning and the landing position of the first ink in the second direction scanning is used. With such a configuration, for example, the deviation between the landing position during primary scanning operation in one orientation and the landing position during primary scanning operation in the other orientation can be appropriately detected. Also, in this way, the correction that reduces such deviation of the landing position can be appropriately performed.

Also, as described above, as the first ink, for example, a translucent ink that does not include a colorant can be used. In contrast, as the first ink, for example, an ink other than the translucent ink that does not include a colorant can be used. In this case, for example, an ink in which the change in the amount of the reflected light due to the presence or absence of the ink on the medium is small, or an ink that includes components that make detection of the reflected light difficult in the optical detection mechanism can be used. Also, more specifically, as the first ink, for example, a white ink can be used. Also, in this configuration, the optical detection mechanism includes, for example, a light projection section that irradiates light to a detection target of reflected light, and a light receiving section that detects the amount of reflected light from the detection target. In this case, the second ink can be considered as, for example, an ink having a different reflectance from the reflectance the first ink with respect to the light irradiated by the light projection section of the optical detection mechanism. Also, in this case, regarding the configuration of the present invention, features focusing on the reflectance can be considered. Also, as the configuration of the present invention, for example, a landing position correction method having the same features as described above or a configuration of a control device can be considered. In such cases as well, for example, the same effects as described above can be obtained.

According to the present invention, for example, in the case where various inks are used in a printing apparatus, landing position correction can be appropriately performed.

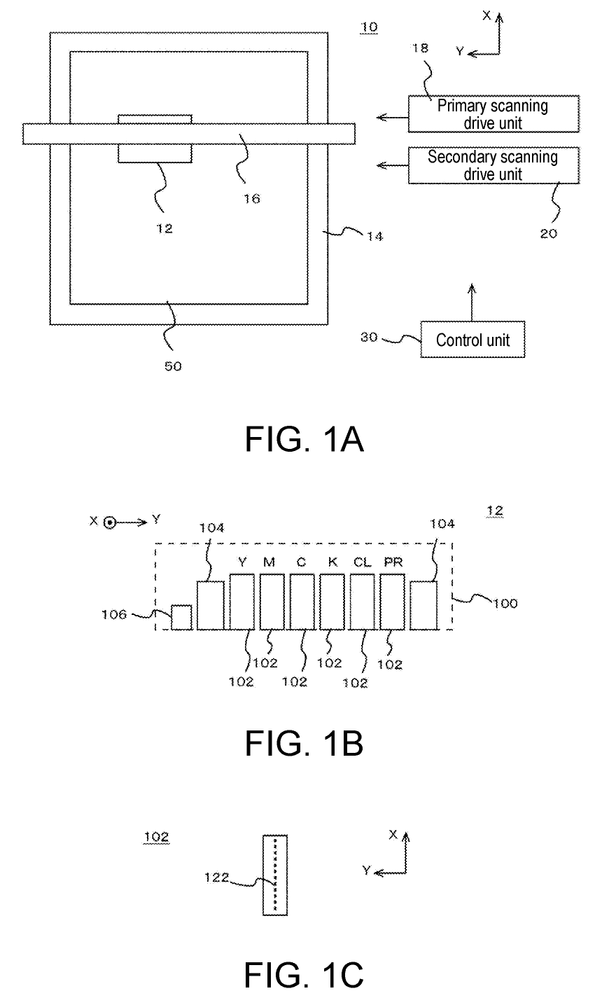

Hereinafter, embodiments according to the present invention will be described with reference to the drawings. FIGS. 1A and 1C are views describing a printing apparatus 10 according to an embodiment of the present invention. FIG. 1A shows an example of a configuration of main components of the printing apparatus 10. FIG. 1B shows an example of a configuration of a head unit 12 in the printing apparatus 10. FIG. 1C shows an example of a configuration of an inkjet head 102 in the head unit 12. Except for the points shown below, the printing apparatus 10 and each component of the printing apparatus 10 of the present embodiment may have the same or similar properties as conventional printing apparatuses and the respective parts thereof. Moreover, the printing apparatus 10 may further have the same or similar configurations as conventional printing apparatuses in addition to the illustrated configuration. In the present embodiment, the printing apparatus 10 is an inkjet printer that performs printing with an inkjet method on a medium (media) 50 that is a target for ink discharge, and the printing apparatus 10 includes a head unit 12, a table 14, a Y-bar 16, a primary scanning drive unit 18, a secondary scanning drive unit 20, and a control unit 30. As the medium 50, for example, a paper, a film, and the like can be suitably used.

The head unit 12 is a portion that discharges an ink to the medium 50, and as shown in FIG. 1B, for example, includes a carriage 100, a plurality of inkjet heads 102, a plurality of ultraviolet light sources 104, and an optical sensor 106. The carriage 100 is a holding member that holds other components in the head unit 12. The plurality of inkjet heads 102 are discharge heads that discharge inks with the inkjet method, and as shown in FIG. 1C, for example, include a nozzle array 122 in which a plurality of nozzles are aligned. In this case, the head unit 12 can be considered to have a plurality of nozzle arrays 122 by having a plurality of inkjet heads 102, for example. Moreover, in the present embodiment, the inkjet head 102 includes a nozzle array 122 in which a plurality of nozzles are aligned with the positions the nozzles shifted from each other in a secondary scanning direction (X direction in the figure) set in advance in the printing apparatus 10. In a modified example of the configuration of the inkjet head 102, the inkjet head 102 may include a plurality of nozzle arrays. Moreover, in the present embodiment, the head unit 12 includes a plurality of inkjet heads 102 that discharge inks of colors different from each other. More specifically, in the illustrated example, the head unit 12 includes inkjet heads 102 for the respective colors of yellow (Y), magenta (M), cyan (C), and black (K), an inkjet head 102 for a clear ink (CL), and an inkjet head 102 for a primer ink (PR).

In this case, the Y, M, C, and K inks are an example of inks for the respective process colors, which are basic colors for color expression. The clear ink and the primer ink are examples of special color inks, which are colors other than the respective process colors. Moreover, in the present embodiment, the clear ink and the primer ink are examples of colorless and transparent inks. With regard to the ink being colorless, it can be considered, for example, that no colorant is intentionally added. The clear ink and the primer ink can also be considered, for example, as translucent inks that do not include colorants. In the present embodiment, the inkjet head 102 for each of the above inks discharges an UV curing type ink, which is an ink that cures through irradiation with ultraviolet light. Moreover, the inkjet heads 102 in the head unit 12 are arranged, for example, with positions thereof aligned in the secondary scanning direction and are arranged side-by-side in a primary scanning direction (Y direction in the figure) orthogonal to the secondary scanning direction. In this case, the secondary scanning direction is an example of an orthogonal direction orthogonal to the primary scanning direction. In a modified example of the configuration of the head unit 12, the inkjet heads 102 may be arranged differently from the above. In this case, for example, it is conceivable to arrange some of the inkjet heads 102 with the positions thereof shifted in the secondary scanning direction from other inkjet heads 102. Moreover, the head unit 12 may include inkjet heads 102 for inks of colors other than those described above. For example, the head unit 12 may include an inkjet head 102 for a white ink as an inkjet head 102 for a special color ink.

The ultraviolet light sources 104 are light sources that irradiate ultraviolet light for curing the UV curing type inks. The ultraviolet light source 104 fixes the ink to the medium 50 by irradiating ultraviolet light to the ink landing on the medium 50. In this case, the ultraviolet light source 104 can also be considered, for example, as a fixing means for fixing the ink to the medium 50. Moreover, in the present embodiment, the ultraviolet light sources 104 are provided on one side and the other side in the primary scanning direction with respect to the arrangement of the inkjet heads 102. Moreover, the optical sensor 106 is an optical detection mechanism that detects reflected light from the medium 50. As the optical sensor 106, for example, a light projector-receiver having a light projection section and a light receiving section can be used as appropriate. In this case, the light projection section irradiates light to the medium 50, which is a detection object (detection body) that is a detection target of the reflected light, for example. Moreover, the light receiving section detects the amount (intensity) of the reflected light from the medium 50. More specifically, as the optical sensor 106, for example, a reflective photosensor such as a conventional diffuse-reflective optical sensor can be used as appropriate. Moreover, in the present embodiment, the optical sensor 106 detects the reflected light at a position corresponding to an adjustment pattern printed on the medium 50. In this case, the reflected light at a position corresponding to the adjustment pattern can be considered, for example, as reflected light reflected by the adjustment pattern or the medium 50 at a position where the adjustment pattern is printed or in the vicinity thereof. Moreover, as the adjustment pattern, a pattern used for correcting the landing position deviation of the ink discharged from the nozzles in the nozzle array 122 of any of the inkjet heads 102 is used. The adjustment pattern used in the present embodiment will be described in more detail later. Moreover, as described above, in the present embodiment, the optical sensor 106 is a configuration included in the head unit 12. In this case, the printing apparatus 10 can be considered to include the head unit 12 and the optical sensor 106 by including the head unit 12, for example. Moreover, depending on how the configuration in the printing apparatus 10 is divided, the optical sensor 106 can also be considered, for example, as a configuration other than the head unit 12. In this case, the printing apparatus 10 can be considered to include the optical sensor 106 separately from the head unit 12, for example.

The table 14 is a platform-shaped member that holds the medium 50 at a position facing the head unit 12. Moreover, in the present embodiment, the table 14 places the entire medium 50 on the upper surface. In this case, the printing apparatus 10 can be considered, for example, as a flatbed type inkjet printer. In a modified example of the configuration of the printing apparatus 10, it may also be that only a portion of the medium 50 is placed on the upper surface of the table 14. In this case, the printing apparatus 10 can be considered, for example, as a vertical type inkjet printer. Moreover, the Y-bar 16 is a configuration that holds the head unit 12 at a position facing the table 14. In the present embodiment, the Y-bar 16 has a guide rail extending in the primary scanning direction, and by holding the carriage 100 of the head unit 12 with the guide rail, guides the movement of the head unit 12 in the primary scanning direction while holding the head unit 12 at a position facing the table 14.

The primary scanning drive unit 18 is a drive section that causes the head unit 12 to perform a primary scanning operation. The primary scanning operation can be considered, for example, as an operation of discharging an ink while moving relatively in the primary scanning direction with respect to the medium 50. Causing the head unit 12 to perform the primary scanning operation can be considered as, for example, causing the inkjet head 102 in the head unit 12 to perform a primary scanning operation. In the present embodiment, the primary scanning drive unit 18 moves the head unit 12 in the primary scanning direction by moving the carriage 100 of the head unit 12 along the guide rail in the Y-bar 16. Moreover, the primary scanning drive unit 18 causes the head unit 12 to perform the primary scanning operation by causing the inkjet head 102, which moves in the primary scanning direction together with the carriage 100, to discharge the ink. The secondary scanning drive unit 20 is a drive section that causes the head unit 12 to perform a secondary scanning operation. The secondary scanning operation can be considered, for example, as an operation of moving relatively in the secondary scanning direction with respect to the medium 50. Causing the head unit 12 to perform the secondary scanning operation can be considered, for example, as causing the inkjet head 102 in the head unit 12 to perform the secondary scanning operation. In the present embodiment, the secondary scanning drive unit 20 moves the head unit 12 together with the Y-bar 16 by moving the Y-bar 16 in the secondary scanning direction. Moreover, in this way, the secondary scanning drive unit 20 causes the head unit 12 to perform the secondary scanning operation. In this case, the secondary scanning drive unit 20 causes the head unit 12 to perform the secondary scanning operation, for example, between primary scanning operations, thereby changing the position facing the head unit 12 on the medium 50 at the time of executing the next primary scanning operation.

The control unit 30 is a configuration that includes, for example, a CPU of the printing apparatus 10, and controls the operation of each section of the printing apparatus 10. More specifically, the control unit 30 causes the head unit 12 to discharge the inks to the discharge positions for printing an image indicated by print data by controlling operations of the head unit 12, the primary scanning drive unit 18, and the secondary scanning drive unit 20 based on the print data, for example. In this case, causing the head unit 12 to discharge the inks to the discharge positions can be considered, for example, as causing the inkjet heads 102 in the head unit 12 to discharge the ink to the discharge positions. Moreover, in the present embodiment, the control unit 30 causes the head unit 12 to discharge the inks to the ink discharge positions associated with an adjustment pattern by controlling the operations of the head unit 12 and the primary scanning drive unit 18, and the like. Then, the control unit 30 performs landing position correction based on the reflected light that the optical sensor 106 detects with respect to the adjustment pattern. In this case, the control unit 30 performs landing position correction by adjusting the discharge timing of causing the nozzle arrays 122 in the inkjet head 102 to discharge the inks for example.

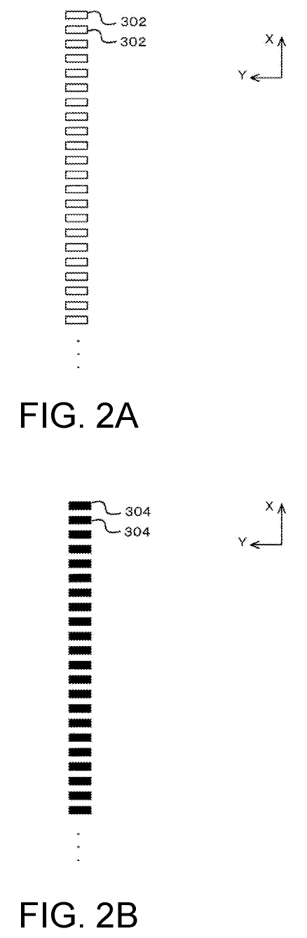

Next, the adjustment pattern used in the present embodiment will be described in more detail. As described above, the adjustment pattern is a pattern used to correct the landing position deviation of the inks discharged from the nozzles in the nozzle arrays 122 of any of the inkjet heads 102. Moreover, in the present embodiment, the adjustment pattern is a pattern that includes a transparent pattern 202 and a colored pattern 204 shown in FIG. 2A and FIG. 2B. FIG. 2A and FIG. 2B are views describing an example of the adjustment pattern. FIG. 2A shows an example of a configuration of the transparent pattern 202 that forms a portion of the adjustment pattern. FIG. 2A shows an example of a configuration of the colored pattern 204 that forms another portion of the adjustment pattern. In the present embodiment, the printing apparatus 10 (see FIG. 1A to FIG. 1C) discharges inks from a first nozzle array, which is a nozzle array 122 (see FIG. 1A to FIG. 1C) of any of the inkjet heads 102 in the head unit 12, to the ink discharge position corresponding to the transparent pattern 202. In this case, the control unit 30 causes the head unit 12 to discharge the ink to the ink discharge position corresponding to the transparent pattern 202, so that the width of the transparent pattern 202 in the secondary scanning direction corresponds to a range in which the nozzles are aligned in one nozzle array 122, for example. Moreover, the first nozzle array is, for example, a nozzle array for the transparent ink. More specifically, in the present embodiment, a nozzle array 122 for the clear ink is used as the first nozzle array. In this case, the clear ink can be considered as an example of the first ink, for example. As the first nozzle array, it is also conceivable to use the nozzle array 122 for the primer ink, for example. Moreover, in the present embodiment, the first nozzle array can be considered as a nozzle array 122 that discharges the first ink, which is the ink of a first color, for example. Moreover, the transparent pattern 202 is an example of a first pattern that is a pattern for causing at least some nozzles in the first nozzle array to discharge the first ink.

Moreover, the printing apparatus 10 discharges an ink from a second nozzle array, which is one nozzle array 122 of any other inkjet head 102 in the head unit 12, to the ink discharge position corresponding to the colored pattern 204. In this case, the control unit 30 causes the head unit 12 to discharge the ink to the ink discharge positions corresponding to the colored pattern 204, so that the width of the colored pattern 204 in the secondary scanning direction corresponds to a range in which the nozzles are aligned in one nozzle array 122, for example. The second nozzle array is, for example, a nozzle array different from the first nozzle array and discharges a colored ink. As the colored ink, it is conceivable to use an ink of a color different from the color of the medium 50. Moreover, in the present embodiment, a nozzle array 122 for a black ink is used as the second nozzle array. As the second nozzle array, it is also conceivable to use a nozzle array 122 for an ink of a color other than black, for example. In this case, as the second nozzle array, it is conceivable to use a nozzle array 122 for any color of process colors, for example. Moreover, in the present embodiment, the second nozzle array can be considered as a nozzle array 122 that discharges the second ink, which is the ink of a colored color different from the first color, for example. In this case, the second ink can also be considered as an ink having a different reflectance from the reflectance of the first ink with respect to the light irradiated by the light projection section of the optical sensor 106, for example. Moreover, the colored pattern 204 is an example of a second pattern that is a pattern for causing at least some nozzles in the second nozzle array to discharge the second ink.

Moreover, in the present embodiment, the control unit 30 (see FIG. 1A to FIG. 1C) detects a deviation amount between the landing position corresponding to the first nozzle array, which is the nozzle array 122 for the clear ink, and the landing position corresponding to the second nozzle array, which is the nozzle array 122 for the colored ink (black ink), based on the intensity of the reflected light detected by the optical sensor 106 (see FIG. 1A to FIG. 1C) with respect to the positions of the transparent pattern 202 and the colored pattern 204. Then, based on the deviation amount, the control unit 30 corrects the landing position corresponding to one of the nozzle arrays 122 by using the landing position corresponding to the other as the reference. More specifically, in this case, the control unit 30 performs correction to reduce the deviation between the landing position of the ink discharged from the nozzles in the nozzle array 122 for the clear ink and the landing position of the ink discharged from the nozzles in the nozzle array 122 for the colored ink, as the landing position correction, for example. Moreover, in the present embodiment, the control unit 30 corrects the landing position corresponding to the nozzle array 122 for the clear ink by using the landing position corresponding to the nozzle array 122 for the colored ink as the reference. In this case, the control unit 30 performs landing position correction by adjusting the timing for causing the nozzles in the nozzle array 122 for the clear ink to discharge the ink, for example. With this configuration, the printing apparatus 10 can appropriately perform landing position correction, for example.

Moreover, in the present embodiment, the transparent pattern 202 is a pattern in which a plurality of strip-shaped element patterns 302 having the primary scanning direction as the longitudinal direction are arranged in the secondary scanning direction with narrow gaps therebetween, as shown in FIG. 2A, for example. The control unit 30 causes the head unit 12 to perform an operation of printing the transparent pattern 202 on the medium 50 (see FIG. 1A to FIG. 1C) by causing the inkjet head 102 for the clear ink to discharge the clear ink to the discharge positions corresponding to the element patterns 302. In this case, the discharge positions corresponding to the element patterns 302 can be considered as the discharge positions for discharging the ink to print the element patterns 302, for example. Moreover, during printing of the transparent pattern 202 in the present embodiment, the control unit 30 causes the ultraviolet light source 104 to irradiate the ultraviolet light so as to cure the clear ink discharged by the nozzle array 122 of the inkjet head 102 for the clear ink in each primary scanning operation during the primary scanning operation, by causing the head unit 12 to perform the primary scanning operation while causing the ultraviolet light source 104 (see FIG. 1A to FIG. 1C) to irradiate ultraviolet light. In this case, the time of printing of the pattern can be considered as the time of discharging the ink to the discharge positions associated with the pattern, for example. Moreover, in this way, at the time of discharging the clear ink to the discharge positions associated with the transparent pattern 202, the control unit 30 causes the ultraviolet light source 104 to irradiate ultraviolet light so that the clear ink is fixed to the medium 50 at the position where the clear ink lands. In this case, the control unit 30 causes the head unit 12 to perform the primary scanning operation by setting the amount of the ultraviolet light irradiated by the ultraviolet light source 104 to a predetermined amount of 100%, for example.

Moreover, in the present embodiment, the control unit 30 causes the head unit 12 to discharge the ink a plurality of times to one discharge position regarding the discharge positions corresponding to the element patterns 302 of the transparent pattern 202. More specifically, in this case, the control unit 30 causes the head unit 12 to discharge the ink a plurality of times to one discharge position by causing the head unit 12 to perform a plurality of primary scanning operations that discharge the ink to the discharge positions corresponding to the element patterns 302, for example. Moreover, in this way, the control unit 30 causes the head unit 12 to form the element patterns 302 that protrude in a convex shape from the surface of the medium 50, for example. Such element patterns 302 can also be considered as patterns in which a plurality of ink layers overlap, for example. Moreover, in the present embodiment, the control unit 30 causes the head unit 12 to discharge the ink to the discharge positions corresponding to the element patterns 302 through a plurality of primary scanning operations having the same movement orientation in the primary scanning direction. With such a configuration, it is possible to appropriately prevent landing position deviation of the ink discharged to the same discharge position, for example. Moreover, in this way, the element patterns 302 can be formed more appropriately, for example. Such element patterns 302 can also be considered as fine strip-shaped structures in which the transparent ink is stacked, for example.

Moreover, the element pattern 302 that is strip-shaped can be considered as being formed by pixels arranged within a rectangular region, for example. In this case, the pixels can be considered as corresponding to the discharge positions from which the ink can be discharged from one nozzle array 122 in one primary scanning operation, for example. More specifically, in the present embodiment, the element pattern 302 is a pattern in which approximately 1 to 5 pixels are arranged in the secondary scanning direction and more pixels are arranged in the primary scanning direction. In this case, the number of pixels arranged in the secondary scanning direction in the element patterns 302 may be one. Moreover, regarding the number of pixels arranged in the secondary scanning direction in the element pattern 302, it is also conceivable to set the number of pixels to approximately 3 to 4, for example. The specific shape of the element pattern 302 can be determined according to the size of the area in which ink dots spread at the position of each pixel (dot gain), for example. Moreover, as described above, in the transparent pattern 202 of the present embodiment, a plurality of element patterns 302 are arranged in the secondary scanning direction with narrow gaps between them. More specifically, in the present embodiment, the gaps between the element patterns 302 have a width that causes a capillary phenomenon with respect to the ink of other colors that contacts the transparent pattern 202. In this case, focusing on the relationship with the colored ink used for forming the colored pattern 204, the transparent pattern 202 can be considered as a pattern having gaps that draw the colored ink that contacts in the liquid state through the capillary phenomenon, for example. Moreover, in this case, the width of the gaps in the transparent pattern 202 (width in the secondary scanning direction) can be considered to correspond to a width that is an integer multiple of the nozzle spacing (nozzle pitch) in the secondary scanning direction in the nozzle array 122. In this case, regarding the width of the gaps, it is conceivable to set the width to appropriately cause the capillary phenomenon with respect to the liquid state according to the properties of the ink that is used, for example. Moreover, regarding the width of the gaps, it can be considered that the minimum width corresponds to the nozzle pitch, for example.

Furthermore, as described above, in the present embodiment, the transparent pattern 202 can be considered as a pattern having gaps that draw the colored ink that contacts in the liquid state through the capillary phenomenon, for example. Moreover, regarding this point, in the phenomenon of drawing the colored ink to the gaps of the transparent pattern 202, it is also conceivable that the magnitude relationship (balance) of the surface energy between the fixed clear ink forming the transparent pattern 202 and the medium 50 is of influence, for example. More specifically, for example, according to the balance of the surface energy, if the fixed clear ink has higher wettability than the medium 50, a force that draws the colored ink to the gaps of the transparent pattern 202 occurs. Therefore, the reason why the gaps of the transparent pattern 202 draw the colored ink can also be considered as not being limited to the capillary phenomenon. Moreover, in this case, it is also conceivable to use a pattern that draws the colored ink to the gaps due to reasons other than the capillary phenomenon as the transparent pattern 202, for example.

Moreover, in the present embodiment, the colored pattern 204 is a pattern in which a plurality of element patterns 304 having the primary scanning direction as the longitudinal direction are aligned in the secondary scanning direction with narrow gaps therebetween, as shown in FIG. 2B, for example. The control unit 30 causes the head unit 12 to perform an operation of printing the colored pattern 204 on the medium 50 by causing the inkjet head 102 for a black ink, which is an example of the colored ink, to discharge the ink to the discharge positions corresponding to the element patterns 304. In this case, the discharge positions corresponding to the element patterns 304 can be considered as the discharge positions for discharging the ink to print the element patterns 304, for example. In the present embodiment, the control unit 30 causes the head unit 12 to discharge the ink to the discharge positions corresponding to the element patterns 304 in the colored pattern 204 through the primary scanning operation in which the movement orientation in the primary scanning direction is the same as the time of discharging the ink to the discharge positions corresponding to the element patterns 302 in the transparent pattern 202. Moreover, during printing of the colored pattern 204 in the present embodiment, the control unit 30 controls the operation of the ultraviolet light source 104, so that the ink after landing can move from the landing position in the liquid state (wet state) by not irradiating with the ultraviolet light source 104 at the time of executing the primary scanning operation that causes the nozzle array 122 for the colored ink to discharge the ink. Moreover, in this way, at the time of discharging the colored ink to the discharge positions associated with the colored pattern 204, the control unit 30 controls the operation of the ultraviolet light source 104 so that the ink after landing can move from the landing position in the liquid state, for example. Such operation can also be considered as an operation that does not cure the ink discharged by the nozzle array 122 of the inkjet head 102 for the black ink in each primary scanning operation at least during the primary scanning operation, for example. In this case, the control unit 30 causes, for example, the ultraviolet light source 104 to irradiate the ultraviolet light at a predetermined light amount of 0%, and causes the head unit 12 to perform the primary scanning operation. Moreover, in this case, it is preferable that the control unit 30 irradiates ultraviolet light to the position of the colored pattern 204 after a certain amount of time has passed after completion of the primary scanning operation that discharges the ink to the discharge positions associated with the colored pattern 204, for example. More specifically, in this case, the control unit 30 causes the ultraviolet light source 104 to perform ultraviolet light irradiation to the positions of the element patterns 304 in the colored pattern 204 after the migration of the colored ink in the liquid state has settled and before detection of reflected light by the optical sensor 106 is performed, for example. With such a configuration, the colored ink in the state after migration can be appropriately fixed to the medium 50, for example. Moreover, in this way, an unintended migration of the colored ink due to unintended contact with the medium 50 can be appropriately prevented, for example. Moreover, according to the environment in which the printing apparatus 10 is used, the control unit 30 may cause the optical sensor 106 to detect the reflected light without causing the ultraviolet light source 104 to perform ultraviolet light irradiation to the position of the colored pattern 204, for example.

Here, in FIG. 2A and FIG. 2B, for the convenience of illustration, the element patterns 302 in the transparent pattern 202 and the element patterns 304 in the colored pattern 204 are simplified and illustrated in rectangular shapes. The actual shape of the element patterns 302 can be considered to be a shape in which ink dots formed at pixel positions are aligned, for example. Moreover, the element patterns 304 in the colored pattern 204 can be considered as formed by a liquid-state ink discharged to pixel positions, for example. The ink forming the element patterns 304 in the colored pattern 204 may move in the liquid state after landing on the medium 50, as described above. Therefore, the element patterns 302 and the element patterns 304 shown in FIG. 2A and FIG. 2B can be considered to show patterns corresponding to the arrangement of pixels corresponding to the ink discharge positions, rather than directly showing patterns actually printed on the medium 50, for example. Moreover, in FIG. 2A and FIG. 2B, for the convenience of illustration and description, the transparent pattern 202 and the colored pattern 204 are individually illustrated regarding the adjustment pattern. During printing of the colored pattern 204 in the actual adjustment pattern, the head unit 12 discharges the colored ink (black ink) to the vicinity of the transparent pattern 202. Moreover, in this case, by discharging the colored ink to the vicinity of the transparent pattern 202, the presence or absence of contact of the colored ink with the transparent pattern 202 and the manner of contact are changed according to the deviation amount between the ink landing position corresponding to the nozzle array 122 for the clear ink and the ink landing position corresponding to the nozzle array 122 for the colored ink, for example.

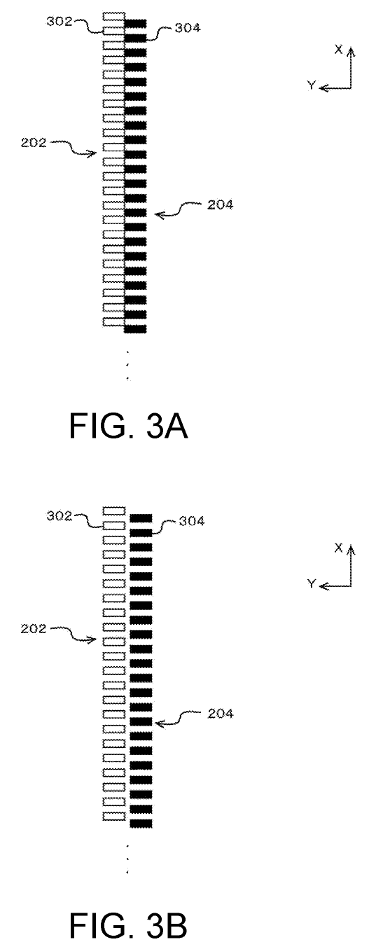

More specifically, in the present embodiment, the control unit 30 causes the nozzles in the nozzle array 122 for the clear ink (first nozzle array) to discharge the clear ink to the ink discharge positions associated with the transparent pattern 202. The ink discharge positions associated with the transparent pattern 202 can be considered as the discharge positions corresponding to the element patterns 302 in the transparent pattern 202, for example. After the clear ink is fixed to the medium 50 by ultraviolet irradiation from the ultraviolet light source 104 during the primary scanning operation, the control unit 30 causes the nozzles in the nozzle array 122 for the colored ink (second nozzle array) to discharge the colored ink to the discharge positions associated with the colored pattern 204 in another primary scanning operation. The ink discharge positions associated with the colored pattern 204 can be considered as the discharge positions corresponding to the element patterns 304 in the colored pattern 204, for example. Moreover, in this case, when the colored ink contacts the transparent pattern 202, with the colored ink being in the liquid state, the colored ink moves according to the manner of contact. In the present embodiment, by discharging the colored ink for the colored pattern 204 to the vicinity of the transparent pattern 202, the presence or absence of contact of the colored ink with the transparent pattern 202 and the manner of contact change according to the amount of landing position deviation, as described above. Moreover, in the present embodiment, the control unit 30 causes the optical sensor 106 to detect the reflected light from the adjustment pattern after the migration of the ink that occurs by the colored ink contacting the transparent pattern 202 in the liquid state. With this configuration, the detection result obtained from the optical sensor 106 can be changed according to the amount of landing position deviation, for example. Therefore, according to the present embodiment, the amount of landing position deviation can be appropriately detected based on the detection result of the optical sensor 106, for example. Moreover, in this way, the landing position correction can be appropriately performed by adjusting the discharge timing for causing the nozzle array 122 to discharge the ink according to the detected amount of landing position deviation, for example. As such an adjustment pattern, more specifically, a pattern shown in FIG. 3A and FIG. 3B can be used, for example.

FIG. 3A and FIG. 3B are views that describe the adjustment pattern used in the present embodiment. FIG. 3A shows an example of the adjustment pattern in an ideal state. The adjustment pattern in the ideal state can be considered as a pattern corresponding to the discharge positions where the ink is discharged in a state where no deviation occurs between the landing position of the ink corresponding to the nozzle array 122 used for forming the transparent pattern 202 and the landing position of the ink corresponding to the nozzle array 122 used for forming the colored pattern 204 (hereinafter simply referred to as landing position deviation), for example. FIG. 3B shows an example of the adjustment pattern in a state where the landing position deviation occurs. The adjustment pattern shown in FIG. 3B can be considered as a pattern corresponding to the discharge positions where the ink is discharged in a state where deviation occurs in the landing positions, for example.

As shown in FIG. 3A and FIG. 3B, in the present embodiment, the element pattern 304 of the colored pattern 204 is printed by discharging the colored ink to position adjacent to the gap region sandwiched between the element patterns 302 of the transparent pattern 202 (positions adjacent in the primary scanning direction). In this case, the element pattern 304 of the colored pattern 204 can also be considered as a gap-corresponding pattern associated with the region sandwiched between the element patterns 302 in the transparent pattern 202, for example. Also, in this case, in the state where no landing position deviation occurs, the element pattern 304 of the colored pattern 204 enters the state where the position of the end of the gap in the primary scanning direction and the position of the end of the element pattern 304 coincide with respect to the gap of the element patterns 302 in the transparent pattern 202. Accordingly, in this case, the colored ink in the liquid state that is discharged to the discharge position corresponding to the element pattern 304 contacts the element patterns 302 at both ends of the gap in the transparent pattern 202, thereby being drawn into the gap due to the capillary phenomenon and the like. Also, in the present embodiment, as the medium 50 for printing the adjustment pattern, a medium is used in which the residual traces of the color of the ink color remain even after the ink moves at the position contacting the colored ink for the colored pattern 204. Such medium 50 can also be considered as a medium in which the colored ink slightly remains outside the transparent pattern 202 even after the colored ink is drawn to the gaps of the element patterns 302 in the transparent pattern 202, for example. And, in the case of using such medium 50, when the colored ink is drawn to the gaps between the element patterns 302 in the transparent pattern 202, the medium 50 enters a state where both the gap portion and the portion where the colored ink are present before migration are colored. In this case, the area to be colored on the medium 50 can be considered to become a wider area than the area where the element pattern 304 is printed in FIG. 3A, for example, due to the influence of the residual trace remaining on the medium 50 after migration of the colored ink.

In contrast, as shown in FIG. 3B, in the case where the landing position deviation occurs and a gap is generated between the transparent pattern 202 and the colored pattern 204, the migration of the colored ink due to the capillary phenomenon and the like as described above does not occur. In this case, the area to be colored on the medium 50 remains, for example, to the area in which the element pattern 304 is printed in FIG. 3B, and thereby differs from the area obtained in the case where no landing position deviation occurs. Also, in the present embodiment, a light-reflective medium such as white is used as the medium 50. And, as the colored ink for the colored pattern 204, an ink of a color different from the color of the medium 50 is used. In this case, for example, by detecting the reflected light from the positions corresponding to the adjustment pattern using the optical sensor 106 (see FIG. 1A to FIG. 1C), whether the landing position deviation occurs can be appropriately detected. Also, in this case, the optical sensor 106 can also be considered to detect the reflected light that changes due to the influence of the residual traces of the color of the colored ink remaining on the medium 50. With such configuration, for example, the influence of the migration of the colored ink can be appropriately detected by the optical sensor 106. Also, in this case, the difference in the detection results of the optical sensor 106 caused by the influence of the residual traces of the color of the colored ink can be considered to occur due to the influence of the transparent pattern 202 formed with the transparent ink, for example. Therefore, with such configuration, for example, the landing position deviation can be appropriately detected even with respect to the nozzle arrays that discharge a transparent ink such as a clear ink. Also, in this way, for example, even in the case where the transparent ink and the like is used in the printing apparatus 10 (see FIG. 1A to FIG. 1C), the landing position correction can be appropriately performed. Therefore, according to the present embodiment, for example, various inks can be used more appropriately in the printing apparatus 10.

Here, as described above, in the present embodiment, the landing position deviation is detected by utilizing the phenomenon in which the colored ink is drawn to the gaps between the element patterns 302 in the transparent pattern 202. In this case, regarding the element pattern 304 of the colored pattern 204, it is preferable to make it into a shape corresponding to the gap in the transparent pattern 202, for example. Regarding making the shape of the element pattern 304 correspond to the gap of the transparent pattern 202, it is conceivable to, for example, make the arrangement of the pixels included in the position of the element pattern 304 the same as the arrangement of the pixels included in the gap region of the transparent pattern 202. By configuring in this way, for example, the influence of the colored ink can be detected more appropriately by using the optical sensor 106.

Also, at the time of executing landing position correction, it is more preferable to detect not only whether the landing position deviation is present but also the amount of the landing position deviation. In this case, it is conceivable to detect the amount of landing position deviation by intentionally shifting the relative position of the colored pattern 204 with respect to the transparent pattern 202 and causing the head unit 12 (see FIG. 1A to FIG. 1C) to discharge the ink to the discharge positions corresponding to the transparent pattern 202 and the colored pattern 204. In this case, for example, it is conceivable to consider a pattern including a set of the transparent pattern 202 and the colored pattern 204 as one patch and use an adjustment pattern including a plurality of patches. Also, in this case, in addition to the patch corresponding to the ideal state shown in FIG. 3A, it is conceivable to further use a patch in which the relative position of the colored pattern 204 with respect to the transparent pattern 202 is intentionally shifted, and to detect the amount of landing position deviation that actually occurs by making the shift amount of the relative position different from each other for each patch in the primary scanning direction. More specifically, in this case, for example, the amount of the residual colored ink corresponding to the ink residual traces remaining outside the transparent pattern 202 after migration of the colored ink varies between patches in which the printing positions of the transparent pattern 202 and the colored pattern 204 are shifted, and the amount of the reflected light also changes accordingly. Also, in this case, for example, instead of quantitatively measuring the amount of ink remaining on the medium 50, the amount of landing position deviation can be appropriately detected by detecting the relative magnitude relationship of the amount of the reflected light among a plurality of patches. In this case, for example, the amount of landing position deviation can be appropriately detected by identifying a peak patch, which is a patch where the optical sensor 106 receives the largest amount of the reflected light (the intensity of the received light is the strongest), or a bottom patch, which is a patch where the optical sensor 106 receives the smallest amount of the reflected light (the intensity of received light is weakest). Also, in this way, for example, the landing position corresponding to the nozzle array 122 for the clear ink can be appropriately corrected based on the landing position corresponding to the nozzle array 122 for the colored ink.

Also, in this case, a plurality of patches, for example, can be considered as patches for grasping the difference in ink concealment rate between the patches by utilizing the difference in the amount of the reflected light between the medium 50 and ink. Also, the operation of detecting the amount of landing position deviation by such a method corresponds to, for example, an operation of determining the appropriate discharge timing from the magnitude of the amount of the reflected light by utilizing the fact that the concealment rate by ink changes for each patch. Also, in this case, the colored pattern 204 in each patch can be considered as, for example, a pattern whose relative position with respect to the transparent pattern 202 is known. The fact that the relative position is known can be considered as, for example, that the relative position in the control setting for the head unit 12 is known. Also, in this case, regarding the positional relationship between the transparent pattern 202 and the colored pattern 204 in the primary scanning direction, for example, contrary to the cases shown in FIG. 3A and FIG. 3B, it is preferable to further use a patch in which the colored pattern 204 is positioned on the left side in the figure with respect to the transparent pattern 202. With such a configuration, for example, the amount of landing position deviation can be detected more appropriately.

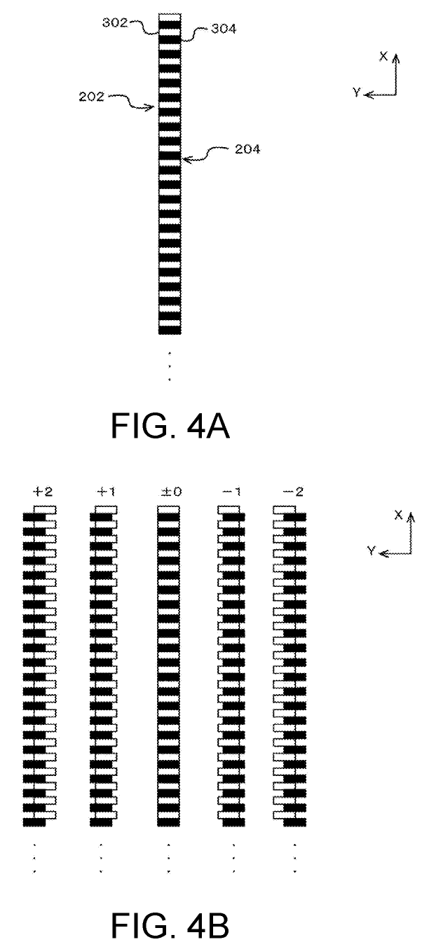

Also, regarding the positional relationship between the transparent pattern 202 and the colored pattern 204 in the patch corresponding to the ideal state, for example, it is conceivable to make it different from the example shown in FIG. 3A and FIG. 3B. In this case, as a patch corresponding to the ideal state, for example, it may be considered to use a patch having the configuration shown in FIG. 4A. FIG. 4A and FIG. 4B are views for describing a modified example of the adjustment pattern. Except for the point described below, in FIG. 4A and FIG. 4B, configurations assigned the same reference numerals as in FIG. 2A and FIG. 2B and FIG. 3A and FIG. 3B may have the same or similar features as the configurations in FIG. 2A and FIG. 2B and FIG. 3A and FIG. 3B. FIG. 4A shows the positional relationship between the transparent pattern 202 and the colored pattern 204 in the patch corresponding to the ideal state in the present modified example. FIG. 4B shows an example of a plurality of patches used in the present modified example. As shown in FIG. 4A, in the patch corresponding to the ideal state in the present modified example, the transparent pattern 202 and the colored pattern 204 are printed at positions aligned in the primary scanning direction, so that the element patterns 304 in the colored pattern 204 overlap with the gaps between the element patterns 302 in the transparent pattern 202. Also, in this case, for example, as shown in FIG. 4B, a plurality of patches are used in which the relative shift amounts in the primary scanning direction between the transparent pattern 202 and the colored pattern 204 are varied from each other. In this case as well, a set of the transparent pattern 202 and the colored pattern 204 printed at adjacent positions can be considered to correspond to one patch.

Also, in the case of the example illustrated in FIG. 4B, a plurality of patches are used in which the relative shift amounts are varied within the range of -2 to +2 in pixel units. In this case, the patches shown in FIG. 4B can be considered to correspond to, for example, the discharge positions where the control unit 30 (see FIG. 1A to FIG. 1C) causes the head unit 12 (see FIG. 1A to FIG. 1C) to discharge the ink in the case where no amount of landing position deviation occurs. Therefore, in the case where the landing position deviation occurs during actual printing of the transparent pattern 202 and the colored pattern 204, the relative positional relationship between the transparent pattern 202 and the colored pattern 204 in each patch changes according to the amount of landing position deviation. Also, in this way, the patches that become peak patches or bottom patches also change. More specifically, for example, regarding the transparent pattern 202 and the colored pattern 204 within the same patch, in the case where the difference in the relative position in the primary scanning direction is small, a large portion of the colored ink corresponding to the element patterns 304 of the colored pattern 204 lands in the gaps between the element patterns 302 in the transparent pattern 202. Accordingly, the amount of the colored ink remaining on the medium 50 outside the transparent pattern 202 is reduced. Also, as a result, the amount of the reflected light at the position of the patch increases. In contrast, regarding the transparent pattern 202 and the colored pattern 204 within the same patch, in the case where the difference in the relative position in the primary scanning direction is large, much of the colored ink corresponding to the element patterns 304 of the colored pattern 204 lands outside the transparent pattern 202. Accordingly, even after the colored ink is drawn to the gaps between the element patterns 302 in the transparent pattern 202, the remaining amount of the colored ink remaining on the medium 50 outside the transparent pattern 202 increases. Also, as a result, the amount of the reflected light at the position of that patch becomes small. And, in this case, for example, by searching for the patch where the amount of the reflected light detected by the optical sensor 106 (see FIG. 1A to FIG. 1C) becomes relatively largest, the amount of landing position deviation can be detected. Therefore, also in the present modified example, for example, based on the detection result by the optical sensor 106, the landing position can be appropriately corrected.

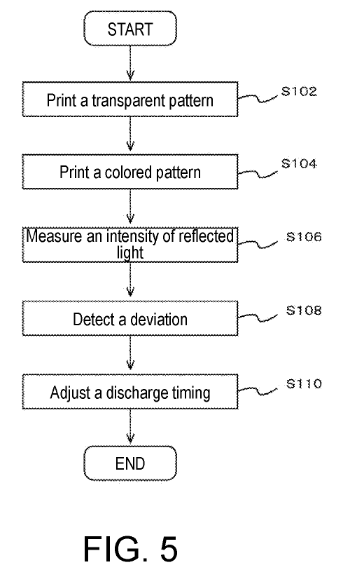

Next, the operation of performing landing position correction in the printing apparatus 10 will be described in more detail by using a flowchart. FIG. 5 is a flowchart showing an example of the operation of performing landing position correction in the printing apparatus 10. In the following, for the convenience of explanation, the operation of the present embodiment will be described by including the case of using the adjustment pattern described with reference to FIG. 4A and FIG. 4B. In the printing apparatus 10 of the present embodiment, in the case of performing landing position correction, the control unit 30 first causes the head unit 12 to perform an operation of printing the transparent pattern 202 between the transparent pattern 202 and the colored pattern 204 in the adjustment pattern (S102). In this case, the operation of printing the transparent pattern 202 can be considered as, for example, an operation of causing the head unit 12 to discharge the ink to the discharge positions corresponding to the element patterns 302 in the transparent pattern 202. Also, in this case, the control unit 30 causes the head unit 12 to perform the operation of printing the transparent pattern 202 by causing the ultraviolet light source 104 in the head unit 12 to irradiate ultraviolet light while causing at least some of the nozzles in the nozzle array of the inkjet head 102 for the clear ink to discharge the ink. In this case, it can be considered that at the time when the operation of Step S102 is completed, the transparent pattern 202 becomes fixed to the medium 50.

Also, following the operation of Step S102, the control unit 30 causes the head unit 12 to perform an operation of printing the colored pattern 204 (S104). In this case, the operation of printing the colored pattern 204 can be considered as, for example, an operation of causing the head unit 12 to discharge the ink to the discharge positions corresponding to the element patterns 304 in the colored pattern 204. Also, in this case, the control unit 30 causes the head unit 12 to perform the operation of printing the colored pattern 204 by causing at least some nozzles in the nozzle array of the inkjet head 102 for the colored ink of any single color such as black to discharge ink without causing the ultraviolet light source 104 in the head unit 12 to irradiate ultraviolet light. In this case, the colored ink at the time of landing on the medium 50 can be considered to be in the liquid state that is able to migrate according to, for example, contact with the transparent pattern 202. As such migration, for example, as described above, the migration of the colored ink due to the capillary phenomenon and the like to the gaps between the element patterns 302 in the transparent pattern 202 can be considered. Also, in Step S104 of the present embodiment, the control unit 30 cures the colored ink by causing the ultraviolet light source 104 to irradiate ultraviolet light after, for example, the migration of the colored ink has settled. The state in which the migration of the colored ink has settled can be considered as, for example, a state in which the migration has substantially completed according to the purpose of detecting the amount of landing position deviation. Also, in this case, the colored ink can be considered to be fixed to the medium 50 after moving due to the contact with the transparent pattern 202. With this configuration, for example, the colored ink in the liquid state can be appropriately brought into contact with the transparent pattern 202 in a state where the clear ink is fixed to the medium 50. Also, in this way, for example, the colored ink can be appropriately moved according to the manner of contact with the transparent pattern 202.

Also, following the operation of Step S104, the control unit 30 causes the optical sensor 106 to detect (measure) the amount of the reflected light at the position of each patch (S106), and detects the amount of landing position deviation based on the detection result of the optical sensor 106 (S108). Then, the control unit 30 performs landing position correction by adjusting the discharge timing for causing the nozzle array of the inkjet head 102 for the clear ink to discharge the ink based on the amount of landing position deviation (S110). In this case, the control unit 30 adjusts the discharge timing by adjusting the timing of changing the voltage of the drive signal that drives the ink in the nozzles of the nozzle array. According to the present embodiment, for example, the landing position correction can be automatically and appropriately performed by using the optical sensor 106. Also, the inventor of the present application confirms through actual experiments that the landing position deviation can be appropriately detected using the adjustment pattern as described above.

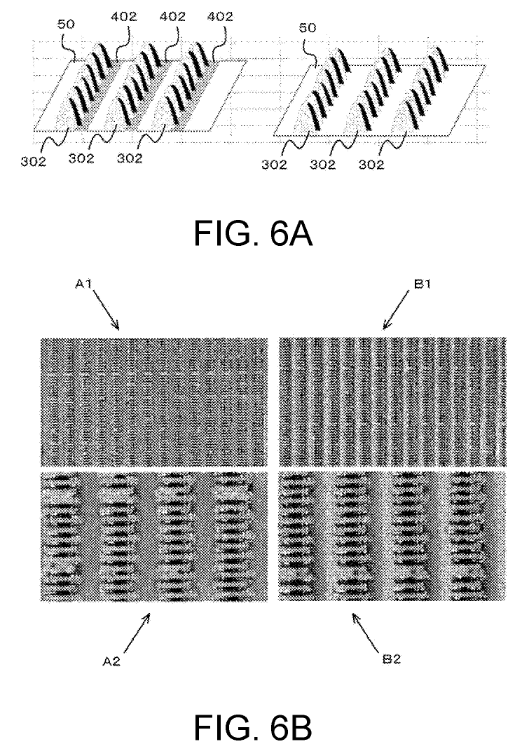

FIG. 6A and FIG. 6B are views describing a part of the experiment conducted by the inventor of the present application. FIG. 6A schematically shows the matters confirmed in this experiment. FIG. 6B shows a photograph of the experimental results. In this experiment, as experimental patterns corresponding to the adjustment patterns, the transparent pattern 202 and the colored pattern 204 (see FIG. 4A and FIG. 4B) aligned in position in the primary scanning direction as shown in FIG. 4A, and the transparent pattern 202 and colored pattern 204 intentionally shifted in position in the primary scanning direction were used. In this case, the transparent pattern 202 and the colored pattern 204 aligned in position in the primary scanning direction can be considered to correspond to a state where no landing position deviation occurs, for example. The transparent pattern 202 and the colored pattern 204 shifted in position in the primary scanning direction can be considered to correspond to a state where the landing position deviation occurs, for example. Also, in FIG. 6A, the left diagram schematically shows a state where the landing position deviation occurs. In this case, as described above, after the colored ink is drawn to the gaps between the element patterns 302 in the transparent pattern 202, residual traces 402 of the colored ink remain on the medium 50. As a result, the amount of the reflected light from the medium 50 decreases at this position. On the other hand, in FIG. 6A, the right diagram schematically shows a state where no landing position deviation occurs. In this case, the colored ink discharged to the discharge position corresponding to the element pattern 304 of the colored pattern 204 lands in the gaps between the element patterns 302 in the transparent pattern 202. Therefore, in this case, no residual traces 402 of the colored ink remain around the transparent pattern 202, and the amount of the reflected light from the medium 50 at this position becomes larger compared to the case of the left diagram.

Also, in FIG. 6B, the photographs marked with reference signs B1 and B2 show the results of actually printing of the transparent pattern 202 and the colored pattern 204 corresponding to the left diagram of FIG. 6A. The photograph marked with reference sign B2 is an enlarged photograph of a portion of the photograph marked with reference sign B1. Also, the photographs marked with reference signs A1 and A2 show the results of actually printing of the transparent pattern 202 and the colored pattern 204 corresponding to the right diagram of FIG. 6A. The photograph marked with reference sign A2 is an enlarged photograph of a portion of the photograph marked with reference sign A1. From the photographs, the presence or absence of the colored ink residual traces 402 described above can also be confirmed. Also, in this case, from this experiment, it can be appropriately confirmed that the landing position deviation can be appropriately detected by using the adjustment patterns as described above, for example.

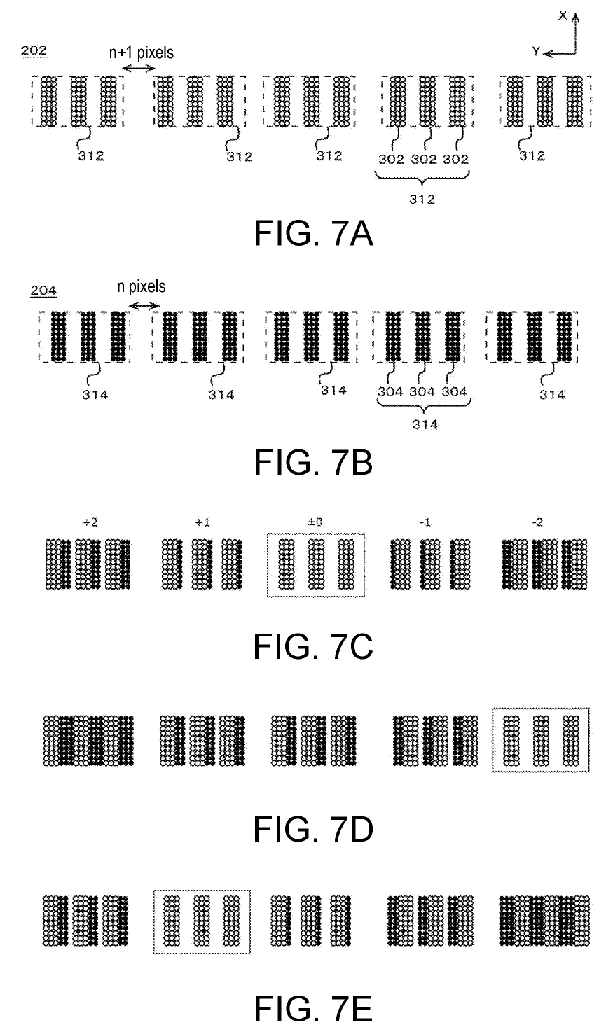

Also, as the adjustment pattern, for example, it is conceivable to use patterns other than the patterns described above. FIG. 7A to FIG. 7Eare views describing a further modified example of the adjustment pattern. Except for the points described below, in FIG. 7A to FIG. 7E, the configurations marked with the same reference signs as FIG. 2A and FIG. 2B to FIG. 4A and FIG. 4B may have the same or similar features as the configurations in FIG. 2A and FIG. 2B to FIG. 4A and FIG. 4B. For example, similar to the configuration of the adjustment pattern illustrated in FIG. 2A and FIG. 2B to FIG. 4A and FIG. 4B and the like, the configuration of the adjustment pattern shown in FIG. 7A to FIG. 7E also shows a pattern corresponding to the arrangement of the pixels corresponding to the discharge positions of the ink. Also, for convenience of illustration, FIG. 7A to FIG. 7E specifically illustrate examples of the arrangement of discharge positions corresponding to the patterns for the element pattern 302 and the element pattern 304 and the like. FIG. 7A shows an example of the configuration of the transparent pattern 202 used in the present modified example. FIG. 7B shows an example of the configuration of the colored pattern 204 used in the present modified example. In the present modified example, the transparent pattern 202 is a pattern in which unit patterns 312, which are predetermined identical patterns, are arranged in the primary scanning direction with constant intervals. More specifically, the unit pattern 312 is a pattern including strip-shaped element patterns 302 having the secondary scanning direction as the longitudinal direction. Also, in the present modified example, the unit pattern 312 is an example of a first unit pattern. In the unit pattern 312, a plurality of element patterns 302 are arranged in the primary scanning direction with narrow gaps therebetween. In this case, the width of the gap between the element patterns 302 within the unit pattern 312 is, for example, the same as the width of the element pattern 302 in the primary scanning direction. Also, in the illustrated example, the element pattern 302 is a pattern having a width of 3 pixels in the primary scanning direction and a length in the secondary scanning direction longer than the width in the primary scanning direction. The width of the element pattern 302 in the primary scanning direction may be other than 3 pixels. In this case, regarding the width of the element pattern 302 in the primary scanning direction, it is preferable to make the width approximately 2 to 5 pixels, for example. Also, in the transparent pattern 202, a plurality of unit patterns 312 are arranged in the primary scanning direction with constant gaps larger than the gaps between the element patterns 302 within the unit pattern 312. More specifically, in the present modified example, the gaps between the element patterns 302 within the unit pattern 312 are gaps of a width that draws the colored ink by the capillary phenomenon and the like in the case where the liquid-state colored ink contacts the element patterns 302 after formation of the transparent pattern 202. In contrast, the gaps between the unit patterns 312 have a width that does not cause such drawing of the colored ink by the capillary phenomenon and the like.

Also, in the present modified example, the colored pattern 204 is also a pattern in which unit patterns 314, which are predetermined identical patterns, are arranged in the primary scanning direction with constant intervals. The unit pattern 314 is also a pattern including the strip-shaped element patterns 304 having the secondary scanning direction as the longitudinal direction. Also, in the present modified example, the unit pattern 314 is an example of a second unit pattern. In the unit pattern 314, a plurality of element patterns 304 are arranged in the primary scanning direction with narrow gaps therebetween. The width of the gaps between the element patterns 304 within the unit pattern 314 is, for example, the same as the width of the element pattern 304 in the primary scanning direction. Also, in the illustrated example, the unit pattern 314 in the colored pattern 204 is the same pattern as the unit pattern 312 in the transparent pattern 202. In the colored pattern 204, a plurality of unit patterns 314 are arranged in the primary scanning direction with constant gaps different from the intervals of the unit patterns 312 in the transparent pattern 202. More specifically, in the case of the illustrated example, the unit patterns 312 in the transparent pattern 202 are arranged in the primary scanning direction with gaps having a width of n+1 (n is a positive integer) pixels. Also, the unit patterns 314 in the colored pattern 204 are arranged in the primary scanning direction with gaps having a width of n pixels.

In this case, with the focus only on the shape of the pattern corresponding to the discharge position where the ink is discharged during pattern printing, it can also be considered that only the intervals of the unit patterns (unit pattern 312 or unit pattern 314) differ between the transparent pattern 202 and the colored pattern 204. However, also in the present modified example, similar to the time of printing of the adjustment pattern described above, the control unit 30 (see FIG. 1A to FIG. 1C) in the printing apparatus 10 causes the head unit 12 (see FIG. 1A to FIG. 1C) to discharge the colored ink used for forming the colored pattern 204, so that the migration in the liquid state occurs due to the contact with the transparent pattern 202, after the clear ink used for forming the transparent pattern 202 is fixed to the medium 50. Therefore, also in the present modified example, for example, the transparent pattern 202 having gaps that draw the colored ink in contact in the liquid state due to the capillary phenomenon and the like and the colored pattern 204 corresponding to the transparent pattern 202 can be appropriately used. Also, in this way, for example, the influence of the migration of the colored ink can be appropriately detected by the optical sensor 106 (see FIG. 1A to FIG. 1C).

Also, in this case, the control unit 30 causes the head unit 12 to discharge the ink to the discharge positions corresponding to the transparent pattern 202 and the colored pattern 204, so that the element patterns 302 included in any unit pattern 312 of the transparent pattern 202 and the element patterns 304 included in any unit pattern 314 of the colored pattern 204 overlap, for example, as shown in FIG. 7C. FIG. 7C is a diagram showing an example of the adjustment pattern used in the present modified example, and shows an example of the adjustment pattern in the ideal state where no deviation in the landing position occurs between the nozzle array used for forming the transparent pattern 202 and the nozzle array used for forming the colored pattern 204. In the adjustment pattern, for example, the transparent pattern 202 and the colored pattern 204 overlap such that one unit pattern 314 in the colored pattern 204 corresponds to one unit pattern 312 in the transparent pattern 202. Therefore, in this case, a portion including one set of the unit pattern 312 and the element patterns 304 can be considered to correspond to, for example, one patch in the adjustment pattern. Also, in this case, the adjustment pattern can be considered to include, for example, a plurality of patches corresponding to mutually different deviation amounts of the landing positions. Also, in the case of the example illustrated in FIG. 7C, in the ideal state, the element patterns 302 of the transparent pattern 202 and the element patterns 304 of the colored pattern 204 overlap at the same position in the central patch surrounded by the rectangle in the figure. In this case, the central patch can be considered as, for example, a patch that overlaps in the case where there is no deviation in landing position. Also, in this case, regarding the amount of landing position deviation compared to the central patch, patches corresponding to amounts of landing position deviation of +1 pixel and +2 pixels are aligned on one side in the primary scanning direction, and patches corresponding to amounts of landing position deviation of -1 pixel and -2 pixels are aligned on the other side in the primary scanning direction.

Also, in this case, in the patch, the colored ink that lands on the element patterns 302 of the transparent pattern 202 is subsequently drawn to the gaps between the element patterns 302 within the patch due to the capillary phenomenon and the like. Also, the colored ink that directly lands in the gaps between the element patterns 302 within the patch spreads within the gaps. In contrast, the colored ink that lands in the wide gaps between the patches remains on the medium 50 without being drawn to the gaps between the element patterns 302. Therefore, also in this case, a change occurs in the amount of the reflected light detected by the optical sensor 106 at the position of the patch according to the amount of landing position deviation. Also, more specifically, for example, in the case of the ideal state shown in FIG. 7C, the amount of the reflected light (received intensity) detected by the optical sensor 106 becomes maximum at the position of the central patch. Also, in the case where the ideal state is not achieved and a deviation in landing position occurs, the amount of the reflected light becomes maximum at the position of a patch at a position other than the center, for example, as shown in FIG. 7D and FIG. 7E. FIG. 7D and FIG. 7E show examples of states where deviations in landing position occur. In this case, the relative position of the colored pattern 204 with respect to the transparent pattern 202 shifts. Accordingly, the amount of the reflected light becomes maximum at the position of the patch surrounded by a rectangle in the figure. In this case, the amount of landing position deviation can be appropriately detected by detecting, for example, the patch where the amount of the reflected light becomes maximum based on the output of the optical sensor 106. Therefore, also in the present modified example, landing position correction can be appropriately performed based on, for example, the detection result by the optical sensor 106.

Next, supplementary explanations regarding each configuration described above and explanations of further modified examples will be described. In the following, for the convenience of explanation, the present embodiment may include the configurations of the modified examples described above or below. As also described above, in the present embodiment, by using a predetermined adjustment pattern, the discharge timing for causing the nozzle array that uses the transparent ink and the like to discharge the ink can be appropriately adjusted. Regarding this point, the transparent ink can be considered as, for example, an ink for which the detection of the amount difference of the reflected light from the medium or the hiding rate of the ink with respect to the medium has been difficult with conventional methods. Therefore, in conventional printing apparatuses, even in the case where a deviation occurs in the landing position of the transparent ink, printing may be performed while ignoring such deviation. As a result, for example, in the case where printing is performed by using the transparent ink on an extremely narrow printing area (pinpoint area and the like) such as a surface portion in a convex part forming braille, the deterioration in print quality may become prominent due to the influence of the deviation in landing position. In contrast, according to the present embodiment, for example, even in the case where printing is performed on the narrow portion with the transparent ink and the like, printing with high quality can be performed more appropriately.

Also, as described above, in the present embodiment, the transparent pattern 202 includes the element patterns 302 that are aligned with narrow gaps therebetween. In this case, the element patterns 302 can be considered as, for example, structures that are separated at predetermined intervals. Also, the gap portions between the element patterns 302 in the transparent pattern 202 can be considered as, for example, portions where the structures are isolated. Also, as described above, in the present embodiment, the gap portions between the element patterns 302 in the transparent pattern 202 draw the liquid-state colored ink due to the capillary phenomenon and the like. In this case, on the medium, residual traces of the ink color remain in portions in contact with the colored ink before the ink migration, for example, even after the ink migration. In this case, portions where the residual traces of the colored ink remain on the medium can also be considered as, for example, portions where the colored ink remains even after most of the colored ink moves due to the capillary phenomenon and the like. Also, portions where the residual traces of the colored ink remain can be considered as, for example, portions where the color and the reflected light amount at such positions change from the original color and reflected light amount of the medium. Also, in this case, portions on the medium where colored ink does not adhere can be considered as, for example, portions where substantially no change occurs from the original color and reflected light amount of the medium. Also, in this case, the change in the portions where the residual traces of the colored ink remain can be considered to correspond to, for example, a change in the hiding rate of the ink. Also, in the present embodiment, as the transparent pattern 202 and the colored pattern 204, for example, patterns in which the element patterns 302 in the transparent pattern 202 and the element patterns 304 in the colored pattern 204 have the same shape can be used. In this case, as the transparent pattern 202 and the colored pattern 204, for example, patterns having the same total discharge amount of ink can be considered. Also, in this case, for the transparent pattern 202, for example, a pattern corresponding to an image with the same discharge amount as the colored ink used to print the colored pattern 204 can be considered. According to the properties of the ink to be used, the amount of ink used for printing the transparent pattern 202 may differ from, for example, the amount of ink used for printing the colored pattern 204. In this case, for example, it is conceivable to increase the amount of the ink used for printing the transparent pattern 202 to form the element patterns 302 with a higher stacking height.

Also, as described above, in the present embodiment, the control unit 30 of the printing apparatus 10 detects, for example, the amount of landing position deviation based on the amount of the reflected light from the positions of a plurality of patches. In this case, the control unit 30 detects the amount of landing position deviation by detecting, for example, the relative magnitude relationship among a plurality of patches regarding the amount of the reflected light. Also, as described above, in the present embodiment, the control unit 30 performs correction of the landing position for the nozzle array that discharges the ink to the discharge position corresponding to the transparent pattern 202, for example, by using the nozzle array for the colored ink that discharges the colored ink to the discharge position corresponding to the colored pattern 204 as a reference. In this case, the ink used for forming the element patterns 302 of the transparent pattern 202 can be considered as, for example, the ink that is a correction target of the landing position (adjustment target for the discharge timing). Also, the colored pattern 204 in the patch can be considered as, for example, a reference patch. The transparent pattern 202 in the patch can be considered as, for example, an adjustment target patch. In contrast, in a modified example of the operation of the printing apparatus 10, for example, the correction of the landing position may be performed for the nozzle array for the colored ink that discharges the colored ink to the discharge position corresponding to the colored pattern 204, by using the nozzle array that discharges the ink to the discharge position corresponding to the transparent pattern 202 as a reference. Also, depending on the configuration of the printing apparatus 10 and the optical sensor 106, instead of detecting the relative magnitude relationship among a plurality of patches regarding the amount of the reflected light, the amount of landing position deviation may be automatically determined by comparing, for example, pre-digitized information with the detection result by the optical sensor 106. In this case, for example, it is conceivable to use information that has been previously stored in the form of data indicating the relationship between the amount of the colored ink remaining on the medium and the reflected light amount.

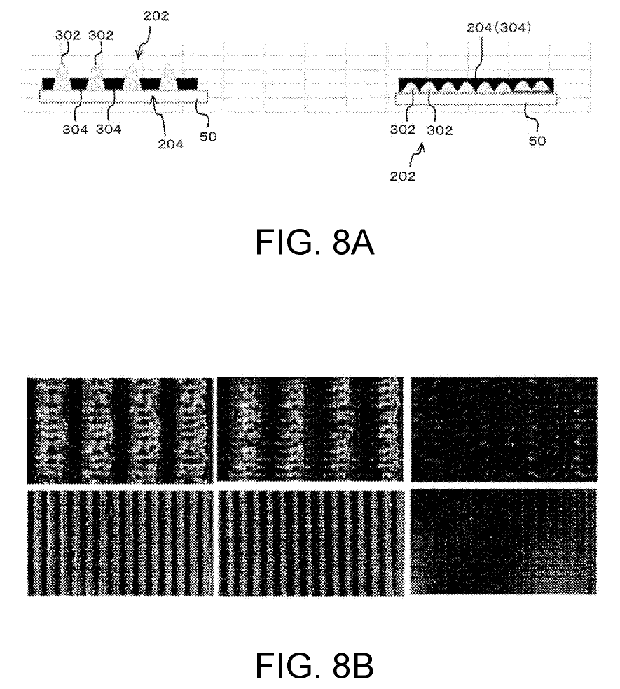

Also, as described above, the adjustment patterns described with reference to FIG. 2A and FIG. 2B to FIG. 7A to FIG. 7E are patterns for detecting the landing position deviation that occurs between a plurality of nozzle arrays different from each other. In this case, for example, by correcting the landing positions between the nozzle arrays included in the inkjet heads 102 (see FIG. 1A to FIG. 1C) different from each other, the landing positions between the inkjet heads can be corrected. Also, the landing position deviation that occurs between a plurality of nozzle arrays may be the deviation that occurs between a plurality of nozzle arrays included in the same inkjet head. On the other hand, as a further modified example of the adjustment pattern, for example, using a pattern for detecting the landing position deviation that occurs in single nozzle array can be considered. In this case, for example, using an adjustment pattern for detecting the deviation between the landing position during the primary scanning operation in one orientation (for example, landing position in the forward direction) and the landing position during the primary scanning operation in the other orientation (for example, landing position in the return direction) in the reciprocating primary scanning operations can be considered. Also, in this case, based on the detection result detected using such an adjustment pattern, as the landing position correction, for example, performing correction to reduce the deviation between the landing position during the primary scanning operation in one orientation and the landing position during primary scanning operation in the other orientation can be considered. More specifically, in this case, for example, detecting the landing position deviation by the method described below with reference to FIG. 8A and FIG. 8B can be considered.

FIG. 8A and FIG. 8B are views for describing a further modified example of the adjustment pattern. FIG. 8A shows the features of the adjustment pattern used in the present modified example in a simplified manner. Except for the points described below, in FIG. 8, configurations assigned the same reference numerals as in FIG. 2A and FIG. 2B to FIG. 4A and FIG. 4B and FIG. 7A to FIG. 7E may have the same or similar features as the configurations in FIG. 2A and FIG. 2B to FIG. 4A and FIG. 4B and FIG. 7A to FIG. 7E. As also described above in relation to FIG. 2A and FIG. 2B and the like, in the case of causing the head unit 12 to print the adjustment pattern shown in FIG. 2A and FIG. 2B to FIG. 4A and FIG. 4B and FIG. 7A to FIG. 7E, the control unit 30 causes the head unit 12 to discharge the ink to the discharge positions corresponding to the element patterns 302 in the transparent pattern 202 through a plurality of primary scanning operations with the same movement orientation in the primary scanning direction. Also, the control unit 30 causes the head unit 12 to discharge the ink to the discharge positions corresponding to the element patterns 304 in the colored pattern 204 through a plurality of primary scanning operations with the same movement orientation in the primary scanning direction as the time of discharging the ink to the discharge positions corresponding to the element patterns 302 in the transparent pattern 202. With this configuration, for example, the correction for reducing the landing position deviation that occurs between the nozzle array for the clear ink and the nozzle array for the colored ink can be appropriately performed.

In contrast, in the case of using the adjustment pattern shown in FIG. 8A and FIG. 8B, the control unit 30 causes the head unit 12 to discharge the ink in the primary scanning operation corresponding to both the one orientation and the other orientation in the primary scanning direction, at least for discharging the link to the discharge positions corresponding to the element patterns 302 in the transparent pattern 202. More specifically, in this case, the primary scanning drive unit 18 (see FIG. 1A to FIG. 1C) in the printing apparatus 10 causes the head unit 12 to perform a forward direction primary scanning operation, which is a primary scanning operation for moving the head unit 12 in the forward direction that is the one orientation in the primary scanning direction, and a return direction primary scanning operation, which is a primary scanning operation for moving the head unit 12 in the return direction that is the other orientation in the primary scanning direction. The forward direction primary scanning operation is an example of first direction scanning that moves the head unit 12 relative to the medium 50 in one orientation in the primary scanning direction. Also, the return direction primary scanning operation is an example of second direction scanning that moves the head unit 12 relative to the medium 50 in the other orientation in the primary scanning direction. In the present modified example, the control unit 30 causes the head unit 12 to discharge the ink in both forward direction and return direction primary scanning operations to the ink discharge positions corresponding to the element patterns 302 in the transparent pattern 202. In this case, with the focus on one nozzle array (first nozzle array) used for forming the transparent pattern 202, the transparent pattern 202 can be considered as, for example, a pattern in which ink dots formed by the ink discharged from at least some of the nozzles in the nozzle array in the forward direction primary scanning operation and ink dots formed by the ink discharged from at least some of the nozzles in the nozzle array in the return direction primary scanning operation overlap. In this case, depending on the presence or absence and the magnitude of the deviation between the ink landing position in the forward direction primary scanning operation and the ink landing position in the return direction primary scanning operation (hereinafter referred to as reciprocating scanning deviation), a difference in the height of the ink stacked in the transparent pattern 202 occurs. More specifically, in this case, in the case where the reciprocating scanning deviation is small, the ink dots formed in the forward direction primary scanning operation and the ink dots formed in the return direction primary scanning operation overlap at the same position, thereby increasing the stacking height at the position of the element pattern 302, for example, as shown in the left diagram in FIG. 8A. On the other hand, in the case where the reciprocating scanning deviation is large, the position where the ink dots formed in the forward direction primary scanning operation are formed and the position where the ink dots formed in the return direction primary scanning operation are formed deviate from each other. Accordingly, the stacking height is reduced, for example, as shown in the right diagram in FIG. 8A.

Also, in the present modified example, the control unit 30 causes the head unit 12 to discharge the colored ink for the colored pattern 204 after the clear ink discharged to the discharge positions corresponding to the transparent pattern 202 has been fixed to the medium 50. In the present modified example, as the colored pattern 204, for example, a pattern is used in which the head unit 12 discharges the colored ink to the discharge positions in the vicinity of the element patterns 302 in the transparent pattern 202. In this case, by bringing the colored ink in liquid state into contact with the transparent pattern 202, the colored ink in the liquid state is caused to cover at least a portion of the transparent pattern 202. Also, in this case, as shown in FIG. 8A and FIG. 8B, for example, the head unit 12 is configured to discharge the colored ink to the discharge positions corresponding to the colored pattern 204 so that the manner in which the colored ink covers the transparent pattern 202 changes according to the stacking height at the positions of the element patterns 302 of the transparent pattern 202. With this configuration, when reciprocating scanning deviation occurs, the stacking height at the positions of the element patterns 302 of the transparent pattern 202 change, thus changing, for example, the range in which the colored ink covers the element patterns 302 of the transparent pattern 202. Also, in this case, the amount of the reflected light from the position of the transparent pattern 202 also varies according to the change in range. More specifically, for example, in the case where the stacking height at the position of the element pattern 302 of the transparent pattern 202 is high and not covered with the colored ink, the medium 50 directly below the element pattern 302 becomes visible, and, as a result, the amount of the reflected light increases. In contrast, in the case where the stacking height at the position of the element pattern 302 of the transparent pattern 202 is low and covered with the colored ink, the medium 50 directly below the element pattern 302 is hidden by the colored ink, and, as a result, the amount of the reflected light decreases. Therefore, according to the present modified example, for example, based on the detection result of the optical sensor 106, the presence or absence of the reciprocating scanning deviation and the magnitude of the deviation can be appropriately detected. Also, in this case, for example, by adjusting the discharge timing for causing the nozzle array to discharge ink according to the presence or absence of the reciprocating scanning deviation and the magnitude of the deviation, landing position correction for reducing the reciprocating scanning deviation can be appropriately performed. Also, regarding the colored pattern 204 used in the present modified example, it can be considered as, for example, a pattern which covers at least a portion of the transparent pattern 202 with the colored ink in liquid state and in which the range covering the transparent pattern 202 changes according to the magnitude of the deviation amount related to the reciprocating scanning deviation.

Also, the inventor of the present application confirmed through actual experiments that the reciprocating scanning deviation can be appropriately detected by using the adjustment pattern as described above. FIG. 8B shows photographs of the experimental results conducted by the inventor of the present application in relation to the adjustment pattern of the present modified example. In FIG. 8B, the two photographs on the left side show a state where the reciprocating scanning deviation is small. Such photographs can be considered as, for example, photographs corresponding to the left diagram in FIG. 8A. Also, the two photographs in the center show a state where the reciprocating scanning deviation becomes larger than the photographs on the left. The two photographs on the right side show a state where the reciprocating scanning deviation becomes even larger than the center photographs. Also, among the two photographs on the left side, center, and right side, respectively, the upper photograph is a photograph showing an enlarged portion of the lower photograph. The lower photograph is a photograph showing a wider range than the upper photograph. From these photographs as well, it can be understood that, for example, the landing position correction for reducing the reciprocating scanning deviation can be carried out by using the adjustment pattern of the present modified example.

Also, as described above, in the printing apparatus 10 of the present embodiment, the inkjet head 102 for each color ink discharges an UV curing type ink. On the other hand, in a modified example of the configuration of the printing apparatus 10, it is conceivable to use an ink other than the UV curing type ink. In this case, the printing apparatus 10 includes, for example, an ink fixing means according to the property of the ink instead of the ultraviolet light source 104 (see FIG. 1A to FIG. 1C) in the head unit 12. More specifically, as the ink other than the UV curing type ink, for example, it is conceivable to use an evaporation-drying type ink that fixes to the medium by drying. In this case, as the evaporation drying type ink, for example, an ink including resin that remains on the medium after drying can be suitably used. With this configuration, for example, the element pattern 302 that protrudes in a convex shape from the surface of the medium can be formed more appropriately. As such evaporation-drying type ink, for example, a latex ink including a polymer material and a solvent can be suitably used. In the case of using the evaporation-drying type ink in the inkjet head 102 as well, regarding the ink discharged to the discharge position corresponding to the element pattern 302 in the transparent pattern 202, the fixing means fixes the ink to the medium before the colored ink for the colored pattern 204 is discharged. Also, in this way, for example, at the time of discharging of the colored ink to the discharge position associated with the colored pattern 204, the control unit 30 causes the head unit 12 to discharge the colored ink in a state where the clear ink for the transparent pattern 202 is fixed to the control unit 30 by drying. Even with this configuration, for example, the colored ink in the liquid state can be appropriately brought into contact with the transparent pattern 202 after the ink is fixed to the medium. Also, in this way, for example, the correction for reducing the deviation of landing position can be appropriately performed in the same or similar manner as described above.

Also, as described above, in the present embodiment, a clear ink is used as the transparent ink for the transparent pattern 202. On the other hand, in a modified example of the operation of the printing apparatus 10, an ink other than the clear ink may be used as the transparent ink for the transparent pattern 202. In this case, for example, it is conceivable to use a primer ink and the like as the transparent ink. The primer ink can be considered, for example, as a transparent ink for base formation and the like. Also, as can be understood from the matters described above and the like, in the present embodiment, the transparent ink for the transparent pattern 202 is an example of a first ink. In a modified example of the operation of the printing apparatus 10, as the first ink, for example, an ink other than transparent ink may be used. In this case, as the first ink, for example, it is conceivable to use an ink with a small change in the amount of reflected light due to the presence or absence of the ink on the medium, or an ink including components that make it difficult to detect the reflected light difficult in the optical sensor 106, and the like. As such ink, for example, it is conceivable to use an ink that does not include the colored colorant, an ink with a small amount of reflected light, or an ink with a high transmittance of visible light, and the like. More specifically, as such first ink, for example, it is conceivable to use an ink of the same color as the medium or an ink of a color close to the medium. Even more specifically, as such first ink, for example, it is conceivable to use a white ink.

Also, as described above, in the present embodiment, the control unit 30 of the printing apparatus 10 performs correction of the landing position by adjusting the discharge timing for causing the nozzle array to discharge the ink. In this case, the control unit 30 can be considered, for example, as an example of a control device that performs the correction of the ink landing position for the printing apparatus. Also, depending on the configuration of the printing apparatus 10 and the like, for example, it is conceivable to perform the correction of the ink landing position for the printing apparatus by using a control device external to the printing apparatus 10. In this case as well, for example, by using the same or similar adjustment pattern as described above, the correction of the landing position can be appropriately performed. As such a control device, for example, a computer that supplies print data to the printing apparatus 10 and the like can be suitably used. Also, in this case, the printing apparatus 10 and the control device can be considered, for example, as configurations included in a printing system and the like.

Also, in the above description, the configuration of the printing apparatus 10 mainly describes the case of discharging the ink onto the medium. In this case, the printing apparatus 10 can be considered, for example, as an inkjet printer and the like that prints a two-dimensional image on the medium. In a modified example of the printing apparatus 10, it is conceivable to use, as the printing apparatus 10, for example, a 3D printer (3D printing apparatus) and the like that forms a three-dimensional shaped object. In this case, a forming table that supports the shaped object during forming or the shaped object during forming can be considered as a target for discharging ink. Also, in this case, for example, in the case of performing the landing position correction, a medium such as paper or film is used as a temporary discharge target for ink. Even in the case of such a configuration, for example, the landing position correction can be appropriately performed. Also, in this case, the printing apparatus 10 can also be considered, for example, as an example of a liquid discharge apparatus and the like.

What is claimed is:

1. A printing apparatus that performs printing with an inkjet method, the printing apparatus comprising:
a head unit, having a nozzle array in which a plurality of nozzles are aligned;
a primary scanning drive unit, causing the head unit to perform a primary scanning operation of discharging an ink while moving in a preset primary scanning direction relative to a medium that serves as a discharge target of the ink;
an optical detection mechanism, detecting reflected light at a position corresponding to an adjustment pattern that is a pattern used for correcting a landing position deviation of the ink discharged from the nozzles in the nozzle array; and
a control unit, by controlling operations of the head unit and the primary scanning drive unit, causing the head unit to discharge the ink to discharge positions of the ink associated with an adjustment pattern and performing landing position correction based on the reflected light detected by the optical detection mechanism,
wherein:
the head unit comprises:
a first nozzle array that is a nozzle array for discharging a first ink which is an ink of a first color; and
a second nozzle array that is a nozzle array for discharging a second ink which is an ink of a colored color different from the first color,
the adjustment pattern comprises:
a first pattern that is a pattern for causing at least some nozzles in the first nozzle array to discharge the first ink; and
a second pattern that is a pattern for causing at least some nozzles in the second nozzle array to discharge the second ink, and
the control unit is configured to:
cause nozzles in the first nozzle array to discharge the first ink to discharge positions associated with the first pattern, and after the first ink is fixed to the medium, cause nozzles in the second nozzle array to discharge the second ink to discharge positions associated with the second pattern; and
cause the optical detection mechanism to detect the reflected light after migration of the second ink that occurs due to the second ink contacting the first pattern in a liquid state.

2. The printing apparatus as claimed in claim 1, wherein the first ink is a translucent ink that does not include a colorant.

3. The printing apparatus as claimed in claim 2, further comprising:
an ultraviolet light source, irradiating ultraviolet light,
the control unit further controls an operation of the ultraviolet light source,
wherein, the first ink and the second ink are UV curing type inks that cure through irradiation of the ultraviolet light,
the controller, when discharging the first ink to the discharge positions associated with the first pattern, causing the ultraviolet light source to irradiate the ultraviolet light, so that the first ink fixes to the medium at a position where the first ink lands, and
the controller, when discharging the second ink to the discharge positions associated with the second pattern, controlling the operation of the ultraviolet light source, so that the second ink after landing is able to move from a landing position in the liquid state.

4. The printing apparatus as claimed in claim 2, wherein the first ink and the second ink are evaporation drying type inks that fix to the medium by drying,
the controller, when discharging the second ink to the discharge position associated with the second pattern, causing at least some of the nozzles in the second nozzle array to discharge the second ink in a state where the first ink is fixed to the medium by drying.

5. The printing apparatus as claimed in claim 2, wherein the first pattern is a pattern having a gap that draws the second ink that contacts in the liquid state,
on the medium, a residual trace of the color of the second ink remains even after migration of the second ink at a position where the second ink contacts, and
the optical detection mechanism detects the reflected light that changes under an influence of the residual trace of the color of the second ink remaining on the medium.

6. The printing apparatus as claimed in claim 5, wherein the first pattern is a pattern in which strip-shaped patterns having the primary scanning direction as a longitudinal direction are aligned in an orthogonal direction orthogonal to the primary scanning direction, and
the second pattern is a pattern in which gap-corresponding patterns associated with regions sandwiched between the strip-shaped patterns are aligned in the orthogonal direction.

7. The printing apparatus as claimed in claim 5, wherein the first pattern is a pattern in which first unit patterns, which are patterns comprising strip-shaped patterns having, as a longitudinal direction, an orthogonal direction orthogonal to the primary scanning direction, are aligned in the primary scanning direction with predetermined intervals,
the second pattern is a pattern in which second unit patterns, which are patterns including strip-shaped patterns having the orthogonal direction as a longitudinal direction, are aligned in the primary scanning direction, and
the second unit patterns in the second pattern are aligned in the primary scanning direction at intervals different from the intervals of the first unit patterns in the first pattern.

8. The printing apparatus as claimed in claim 1, wherein the control unit corrects a landing position corresponding to one of the first nozzle array and the second nozzle array by using a landing position corresponding to an other of the first nozzle array and the second nozzle array as reference.

9. The printing apparatus as claimed in claim 1, wherein the primary scanning drive unit causes the head unit to perform: first direction scanning, which is the primary scanning operation that moves the head unit relative to the medium in an orientation in the primary scanning direction; and second direction scanning, which is the primary scanning operation that moves the head unit relative to the medium in an other orientation in the primary scanning direction,
the first pattern is a pattern in which ink dots formed by the ink discharged from at least some nozzles in the first nozzle array during the first direction scanning and ink dots formed by the ink discharged from at least some nozzles in the first nozzle array during the second direction scanning overlap, and
the second pattern is a pattern which covers at least a portion of the first pattern with the second ink in the liquid state, and in which a range covering the first pattern changes according to a magnitude of an amount of the landing position deviation between a landing position of the first ink during the first direction scanning and a landing position of the first ink during the second direction scanning.

10. A landing position correction method for performing landing position correction of an ink with respect to a printing apparatus that performs printing with an inkjet method,
wherein:
a head unit having a nozzle array in which a plurality of nozzles are aligned and an optical detection mechanism detecting reflected light at a position corresponding to an adjustment pattern that is a pattern used for correcting a landing position deviation of the ink discharged from the nozzles in the nozzle array are used, and the landing position correction method comprises:
causing the head unit to perform a primary scanning operation of discharging the ink while moving in a preset primary scanning direction relative to a medium that is a discharge target of the ink, and
causing the head unit to discharge the ink to discharge positions of the ink associated with the adjustment pattern, and performing landing position correction based on the reflected light detected by the optical detection mechanism,
the head unit comprises:
a first nozzle array that is a nozzle array for discharging a first ink which is an ink of a first color; and
a second nozzle array that is a nozzle array for discharging a second ink which is an ink of a colored color different from the first color,
the adjustment pattern comprises:
a first pattern that is a pattern for causing at least some nozzles in the first nozzle array to discharge the first ink; and
a second pattern that is a pattern for causing at least some nozzles in the second nozzle array to discharge the second ink, and
the landing position correction method further comprises:
causing nozzles in the first nozzle array to discharge the first ink to discharge positions associated with the first pattern, and after the first ink is fixed to the medium, causing nozzles in the second nozzle array to discharge the second ink to discharge positions associated with the second pattern; and
causing the optical detection mechanism to detect the reflected light after migration of the second ink that occurs due to the second ink contacting the first pattern in a liquid state.

11. The landing position correction method as claimed in claim 10, wherein the first ink is a translucent ink that does not include a colorant.

12. A control device for performing landing position correction of an ink with respect to a printing apparatus that performs printing with an inkjet method,
wherein the printing apparatus comprises:
a head unit, having a nozzle array in which a plurality of nozzles are aligned;
a primary scanning drive unit, causing the head unit to perform a primary scanning operation of discharging an ink while moving in a preset primary scanning direction relative to a medium that serves as a discharge target of the ink; and
an optical detection mechanism, detecting reflected light at a position corresponding to an adjustment pattern that is a pattern used for correcting a landing position deviation of the ink discharged from the nozzles in the nozzle array,
the head unit comprises:
a first nozzle array that is a nozzle array for discharging a first ink which is an ink of a first color; and
a second nozzle array that is a nozzle array for discharging a second ink which is an ink of a colored color different from the first color,
the adjustment pattern comprises:
a first pattern that is a pattern for causing at least some nozzles in the first nozzle array to discharge the first ink; and
a second pattern that is a pattern for causing at least some nozzles in the second nozzle array to discharge the second ink, and
the control device is configured to:
by controlling operations of the head unit and the primary scanning drive unit, cause the head unit to discharge the ink to discharge positions of the ink associated with the adjustment pattern and perform landing position correction based on the reflected light detected by the optical detection mechanism,
cause nozzles in the first nozzle array to discharge the first ink to discharge positions associated with the first pattern, and after the first ink is fixed to the medium, cause nozzles in the second nozzle array to discharge the second ink to discharge positions associated with the second pattern, and
cause the optical detection mechanism to detect the reflected light after migration of the second ink that occurs due to the second ink contacting the first pattern in a liquid state.

13. The control device as claimed in claim 12, wherein the first ink is a translucent ink that does not include a colorant.

14. The control device as claimed in claim 13, wherein the printing apparatus further comprising:
an ultraviolet light source, irradiating ultraviolet light,
wherein the control device further controls an operation of the ultraviolet light source,
the first ink and the second ink are UV curing type inks that cure through irradiation of the ultraviolet light,
at a time of discharging the first ink to the discharge positions associated with the first pattern, the control device causes the ultraviolet light source to irradiate the ultraviolet light, so that the first ink fixes to the medium at a position where the first ink lands,
at a time of discharging the second ink to the discharge positions associated with the second pattern, the control device controls the operation of the ultraviolet light source, so that the second ink after landing is able to move from a landing position in the liquid state.

15. The control device as claimed in claim 13, wherein the first ink and the second ink are evaporation drying type inks that fix to the medium by drying,
at the time of discharging the second ink to the discharge position associated with the second pattern, the control device causes at least some of the nozzles in the second nozzle array to discharge the second ink in a state where the first ink is fixed to the medium by drying.

16. The control device as claimed in claim 13, wherein the first pattern is a pattern having a gap that draws the second ink that contacts in the liquid state,
on the medium, a residual trace of the color of the second ink remains even after migration of the second ink at a position where the second ink contacts, and
the optical detection mechanism detects the reflected light that changes under an influence of the residual trace of the color of the second ink remaining on the medium.

17. The control device as claimed in claim 16, wherein the first pattern is a pattern in which strip-shaped patterns having the primary scanning direction as a longitudinal direction are aligned in an orthogonal direction orthogonal to the primary scanning direction, and
the second pattern is a pattern in which gap-corresponding patterns associated with regions sandwiched between the strip-shaped patterns are aligned in the orthogonal direction.

18. The control device as claimed in claim 16, wherein the first pattern is a pattern in which first unit patterns, which are patterns comprising strip-shaped patterns having, as a longitudinal direction, an orthogonal direction orthogonal to the primary scanning direction, are aligned in the primary scanning direction with predetermined intervals,
the second pattern is a pattern in which second unit patterns, which are patterns including strip-shaped patterns having the orthogonal direction as a longitudinal direction, are aligned in the primary scanning direction, and
the second unit patterns in the second pattern are aligned in the primary scanning direction at intervals different from the intervals of the first unit patterns in the first pattern.

19. The control device as claimed in claim 12, wherein the control device corrects a landing position corresponding to one of the first nozzle array and the second nozzle array by using a landing position corresponding to an other of the first nozzle array and the second nozzle array as reference.

20. The control device as claimed in claim 12, wherein the primary scanning drive unit causes the head unit to perform: first direction scanning, which is the primary scanning operation that moves the head unit relative to the medium in an orientation in the primary scanning direction; and second direction scanning, which is the primary scanning operation that moves the head unit relative to the medium in an other orientation in the primary scanning direction,
the first pattern is a pattern in which ink dots formed by the ink discharged from at least some nozzles in the first nozzle array during the first direction scanning and ink dots formed by the ink discharged from at least some nozzles in the first nozzle array during the second direction scanning overlap, and
the second pattern is a pattern which covers at least a portion of the first pattern with the second ink in the liquid state, and in which a range covering the first pattern changes according to a magnitude of an amount of the landing position deviation between a landing position of the first ink during the first direction scanning and a landing position of the first ink during the second direction scanning.
